(19) United States
(12) Patent Application Publication
(10) Pub. No.: US 2025/0286728 A1
(43) Pub. Date: Sep. 11, 2025

(54) FLEXIBLE ACCESS CONTROL USING EXPRESSIVE MONOTONE-POLICY AGGREGATE SIGNATURES

(71) Applicant: NTT Research, Inc., Sunnyvale, CA (US)

(72) Inventors: Maya Farber Brodsky, Tel Aviv (IL); Arka Rai Choudhuri, Emeryville, CA (US); Abhishek Jain, Baltimore, MD (US); Omer Paneth, Tel Aviv (IL)

(73) Assignee: NTT Research, Inc., Sunnyvale, CA (US)

(21) Appl. No.: 19/076,922

(22) Filed: Mar. 11, 2025

Related U.S. Application Data
(60) Provisional application No. 63/563,916, filed on Mar. 11, 2024.

(51) Int. Cl. H04L 9/32; H04L 9/08

(52) U.S. Cl. CPC H04L 9/3247; H04L 9/0825; H04L 9/3236

(57) ABSTRACT

A method and system for generating and verifying a monotone policy aggregate signature σf a message. The method involves storing a common message at a local storage device, generating a signature for the common message using a secret cryptographic key at a local signature generation module, and transmitting the user signature to an aggregator module. The aggregator module combines the user signature with other user signatures to generate an aggregate signature. The aggregate signature is then transmitted to a verification module for verification. The monotone policy aggregate signatures are constructed from non-interactive batch arguments that support adaptive subset extraction for expressive monotone policies.

### CROSS-REFERENCE TO RELATED APPLICATION

This application claims the benefit of U.S. Provisional Application Ser. No. 63/563,916 filed Mar. 11, 2024, the content of which is incorporated by reference herein in its entirety.

### FIELD OF INVENTION

The present disclosure generally relates to the field of cryptographic signature schemes, and more specifically, to systems and methods for generating and verifying aggregate signatures for expressive monotone policies.

### BACKGROUND

In the domain of digital security, the concept of expressive monotone policies over signatures has gained prominence as a means to enhance the flexibility and specificity of access control mechanisms. These policies enable fine-grained control over the authentication process by defining conditions under which a collective set of signatures is considered valid. Expressive monotone policies are particularly useful in scenarios where multiple signatories are involved, and the validity of a document or transaction depends on a complex combination of their approvals.

Expressive monotone policies can include a variety of logical constructs such as “AND,” “OR,” and threshold conditions, allowing for intricate policy definitions. For instance, a policy might require that a message be signed by at least three out of five designated authorities, or by one department head in conjunction with two staff members. The expressiveness of these policies, however, introduces several challenges in their implementation and enforcement.

A primary issue with expressive monotone policies is the computational complexity associated with verifying signatures against intricate policy conditions. As the number of signatories and the complexity of the policy increase, the verification process can become computationally intensive, potentially impacting system performance and scalability. This is particularly problematic in distributed systems, where resources may be limited and efficiency is of the essence.

Another challenge is the potential for ambiguity in policy interpretation, which can lead to inconsistencies in signature verification. Ensuring that all parties involved in the signature process have a consistent understanding and implementation of the policy is paramount to maintaining the integrity of the system.

Additionally, the dynamic nature of organizational structures and roles can complicate the management of expressive monotone policies. Changes in personnel or organizational hierarchy may necessitate frequent updates to the policies, which can be cumbersome and error-prone. This fluidity requires robust policy management tools that can adapt to changes without compromising security or introducing vulnerabilities.

Furthermore, the enforcement of expressive monotone policies often requires sophisticated cryptographic techniques that can support complex logical conditions while preserving the privacy and anonymity of the signatories. This is especially challenging in the context of blockchain networks and other decentralized systems, where transparency and immutability are core principles.

Despite these challenges, the implementation of expressive monotone policies over signatures remains a sought-after feature in modern cryptographic systems. The ability to specify and enforce complex signing requirements is integral to the security and functionality of various digital platforms, from corporate document management systems to blockchain-based smart contracts. As such, there is a continuous pursuit of advanced cryptographic solutions that can efficiently and securely handle expressive monotone policies.

### SUMMARY OF INVENTION

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a method for generating an aggregate signature of a message is provided. The method includes storing a common message at a local storage device.

At a local key generation module, a secret cryptographic signing key and a public cryptographic verification key pair for a user are generated using a collision-resistant hash function, and the public cryptographic verification key is transmitted to a hash generation module. At a local signature generation module, a user signature for the common message is generated using the secret cryptographic signing key for the user. The user signature is transmitted to an aggregator module. At the aggregator module, the user signature for the common message is combined with other user signatures for the common message received from other users to generate an aggregate signature using non-interactive batch arguments. The aggregate signature is transmitted to a verification module. The aggregate signature is constructed from the non-interactive batch arguments that support adaptive subset extraction for expressive monotone policies. A size of the aggregate signature is sublinear in a number of signers and is based on a security parameter λ. The non-interactive batch arguments are constructed from verifiable private information retrieval. The aggregate signature is capable of being verified in sublinear time O(log k) when all parties sign the common message, where k is the number of signers.

According to other aspects of the present disclosure, the method may include one or more of the following features. The non-interactive batch arguments that support adaptive subset extraction for monotone policies may be constructed from Verifiable Private Information Retrieval.

An untrusted aggregator party may combine the signatures of multiple parties into an aggregate signature \hat{σ} to certify expressive monotone policies over the signatures. At least t out of k parties may have signed a message. The method may further include weighted thresholds where each party has a different weight and a signing policy is defined with respect to a sum of the party weights. The method may rely only on standard cryptographic assumptions. The constructions may be in the common reference string (CRS) model where the size of the CRS grows only polylogarithmically in the number of signers. The size of the aggregate signature may be sublinear in k and t and only depend on a security parameter. If all parties sign the same message, the verification time may be sublinear in t. If a vector of messages has a succinct representation, the verification time may be sublinear in t. The aggregation time may grow with a number of signatures t and not a number of parties k.

According to another aspect of the present disclosure, a method for verifying an aggregate signature σf a message is provided. The method includes storing a common message at a local storage device. At a local key generation module, a secret key and a verification key pair for a user are generated, and the verification key is transmitted to a hash generation module. At a local signature generation module, a user signature for the common message is generated using the secret key for the user. The user signature is transmitted to an aggregator module. At the aggregator module, the user signature for the common message is combined with other user signatures for the common message received from other users to generate an aggregate signature.

The aggregate signature is transmitted to a verification module. At the verification module, the common message that has been signed by multiple users is received. The aggregate signature for the signed common message is received. Verification keys from one or more of the multiple users that signed the common message are received. A hash digest of the received verification keys is generated. The aggregate signature for the signed common message is verified based on the hash digest of the received verification keys, the common message, and the aggregate signature for the signed common message. A result of the aggregate signature verification is stored. The aggregate signatures are constructed from non-interactive batch arguments that support adaptive subset extraction for expressive monotone policies.

According to other aspects of the present disclosure, the verification may be performed without knowing the identity of the signers.

According to another aspect of the present disclosure, an apparatus for generating an aggregate signature σf a message is provided. The apparatus includes a local storage device configured to store a common message. A local key generation module is configured to generate a secret key and a verification key pair for a user, and transmit the verification key to a hash generation module. A local signature generation module is configured to generate a user signature for the common message using the secret key for the user. A transmission module is configured to transmit the user signature to an aggregator module. The aggregator module is configured to combine the user signature for the common message with other user signatures for the common message received from other users to generate an aggregate signature. The transmission module is further configured to transmit the aggregate signature to a verification module. The aggregate signature is constructed from non-interactive batch arguments that support adaptive subset extraction for expressive monotone policies. A size of the aggregate signature is sublinear in a number of signers and is based on a security parameter λ. The non-interactive batch arguments are constructed from verifiable private information retrieval. The aggregate signature is capable of being verified in sublinear time O(log k) when all parties sign the common message, where k is the number of signers.

According to other aspects of the present disclosure, the apparatus may include one or more of the following features. The non-interactive batch arguments that support adaptive subset extraction for monotone policies may be constructed from Verifiable Private Information Retrieval. An untrusted aggregator party may combine the signatures of multiple parties into an aggregate signature to certify expressive monotone policies over the signatures. At least a threshold number of parties may have signed a message. The apparatus may further comprise a weighted threshold module where each party has a different weight and a signing policy is defined with respect to a sum of the party weights. The method may rely on standard cryptographic assumptions. The constructions may be in the common reference string (CRS) model where the size of the CRS grows polylogarithmically with the number of signers. The size of the aggregate signature may be sublinear in the number of signers and the threshold number of signers and depend on a security parameter. If all parties sign the same message, the verification time may be sublinear in the threshold number of signers. If a vector of messages has a succinct representation, the verification time may be sublinear in the threshold number of signers. The aggregation time may grow with the number of signatures and not the number of parties.

According to another aspect of the present disclosure, an apparatus for verifying an aggregate signature σf a message is provided. The apparatus includes a local storage device configured to receive a common message that has been signed by multiple users. A first reception module is configured to receive an aggregate signature for the signed common message. A second reception module is configured to receive verification cryptographic keys from one or more of the multiple users that signed the common message. A hash generation module is configured to generate a hash digest of the received verification cryptographic keys. A verification module is configured to verify the aggregate signature for the signed common message based on the hash digest of the received verification cryptographic keys, the common message, and the aggregate signature for the signed common message. A storage module is configured to store a result of the aggregate signature verification. The aggregate signatures are constructed from non-interactive batch arguments that support adaptive subset extraction for expressive monotone policies.

According to other aspects of the present disclosure, the verification may be performed without knowing the identity of the signers.

The notion of aggregate signatures allows for combining signatures from different parties into a short certificate that attests that all parties signed a message. In this work, we lift this notion to capture different, more expressive signing policies. For example, we can certify that a message was signed by a (weighted) threshold of signers.

We present the first constructions of aggregate signatures for monotone policies based on standard polynomial-time cryptographic assumptions. The size of the signatures and the verifier time in our schemes is independent of the number of signers. All prior work requires either interaction between the parties or non-standard assumptions (that imply SNARKs for NP).

Our signature schemes are based on non-interactive batch arguments (BARGs) for monotone policies [Brakerski-Brodsky-Kalai-Lombardi-Paneth, Crypto'23]. In contrast to previous constructions, our BARGs satisfy a new notion of adaptive security which is instrumental to our application. Our new BARGs for monotone policies can be constructed from standard BARGs and other standard assumptions.

The foregoing general description of the illustrative embodiments and the following detailed description thereof are merely exemplary aspects of the teachings of this disclosure and are not restrictive.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates example Aggregate Signatures for Bounded Space Monotone Policies f from BARGs with Adaptive Subset Extraction for f.

FIG. 2 illustrates example Weakly Unforgeable Aggregate Signatures for Monotone Circuits f.

FIG. 3 illustrates an example construction of 2-Composable vPIR Scheme for Policies.

FIG. 4 illustrates an example construction of BARGs with Adaptive Subset Extraction for bounded-space policies.

FIG. 5 illustrates an example construction of Sublinear Prover BARGs for weighted threshold policies.

FIG. 6 illustrates an example construction of BARGs with Functional Subset Extraction.

FIG. 7 presents a block diagram of an aggregate signature generation and verification apparatus, including the process of generating and verifying digital signatures using various cryptographic schemes.

FIG. 8 depicts a flowchart of a method for generating an aggregate signature, illustrating the step-by-step process involved in the generation of digital signatures.

FIG. 9 illustrates a flowchart for a method of verifying an aggregate signature, detailing the steps involved in the verification of an aggregate signature.

FIG. 10 presents a block diagram of a computer system, demonstrating the hardware components involved in the implementation of the cryptographic signature scheme.

FIG. 11 presents a block diagram of a system architecture for processing and managing data, highlighting the system architecture used for implementing the cryptographic signature scheme.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure relates to the field of cryptography, and more particularly, to methods and systems for generating and verifying aggregate signatures of a message. In some aspects, the disclosure provides methods and systems for generating an aggregate signature σf a message, where multiple parties sign a common message, and these individual signatures are combined into a single aggregate signature. This aggregate signature can then be verified to ensure the authenticity and integrity of the message.

In some embodiments, the methods and systems disclosed herein can be implemented in various types of computer systems and software tools, including local, cloud-based, or distributed systems. The choice of implementation can depend on various factors, such as the specific requirements of the system, the performance requirements, and the security considerations. The disclosed methods and systems can provide a secure and efficient way to authenticate and verify digital messages, thereby enhancing the security and reliability of data transmission in various applications.

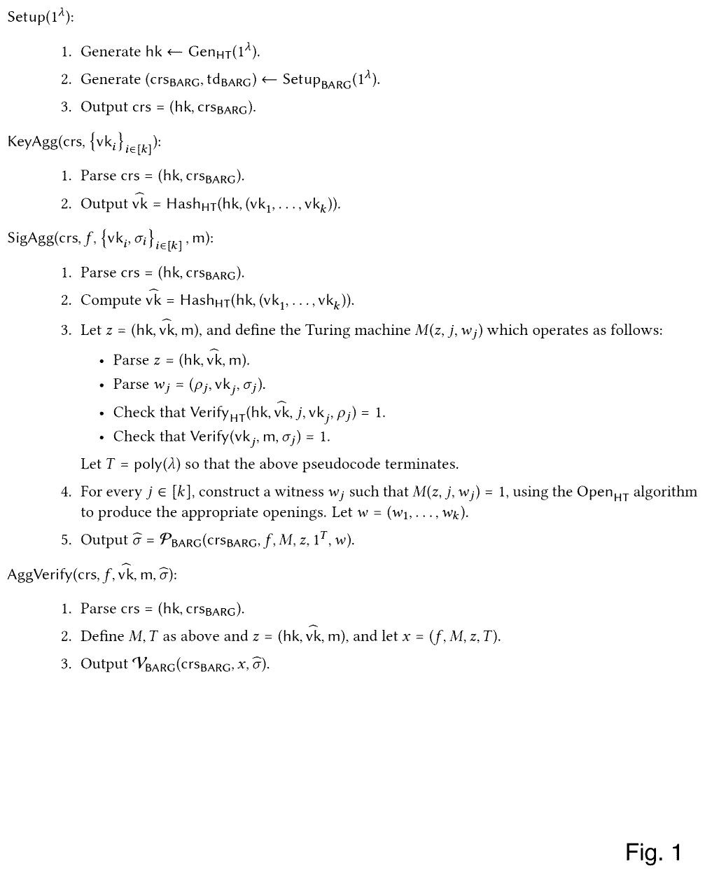

In some cases, the signature system 100 may implement a method for generating and verifying aggregate signatures for expressive monotone policies. The method may involve several key components and processes, as illustrated in FIGS. 1-6.

FIG. 1 depicts an example of aggregate signatures for bounded space monotone policies f from batch arguments (BARGs) with adaptive subset extraction for f. The process may begin with a Setup procedure that takes a security parameter 1^{λ} as input. This procedure may generate a hash key hk using a function Gen_{HT}(1^{λ}). Additionally, it may generate a common reference string and trapdoor pair (crs_{BARG}, td_{BARG}) using Setup_{BARG}(1^{λ}). The output of this setup phase may be a common reference string crs=(hk, crs_{BARG}).

The KeyAgg procedure, as shown in FIG. 1, may take the common reference string crs and a set of verification keys {vkᵢ}_{i∈[k]} as input. This procedure may parse the common reference string to extract the hash key hk. It may then compute an aggregate verification key [symbol] =Hash_{HT}(hk, (vk₁, . . . , vkₖ)) using the hash function.

The SigAgg procedure illustrated in FIG. 1 may be responsible for generating the aggregate signature. This procedure may take as input the common reference string crs, a monotone policy f, a set of verification key and signature pairs {vkᵢ, σᵢ}_{i∈[k]}, and a message m. The procedure may parse the common reference string, compute the aggregate verification key, and define a parameter z=(hk, [symbol] , m). It may also define a Turing machine M(z, j, wⱼ) with specific operational parameters. The procedure may construct witnesses wⱼ using an Open_{HT} algorithm and finally output an aggregate signature \hat{σ}= [symbol] _{BARG}(crs_{BARG}, f, M, z, 1^{T}, w).

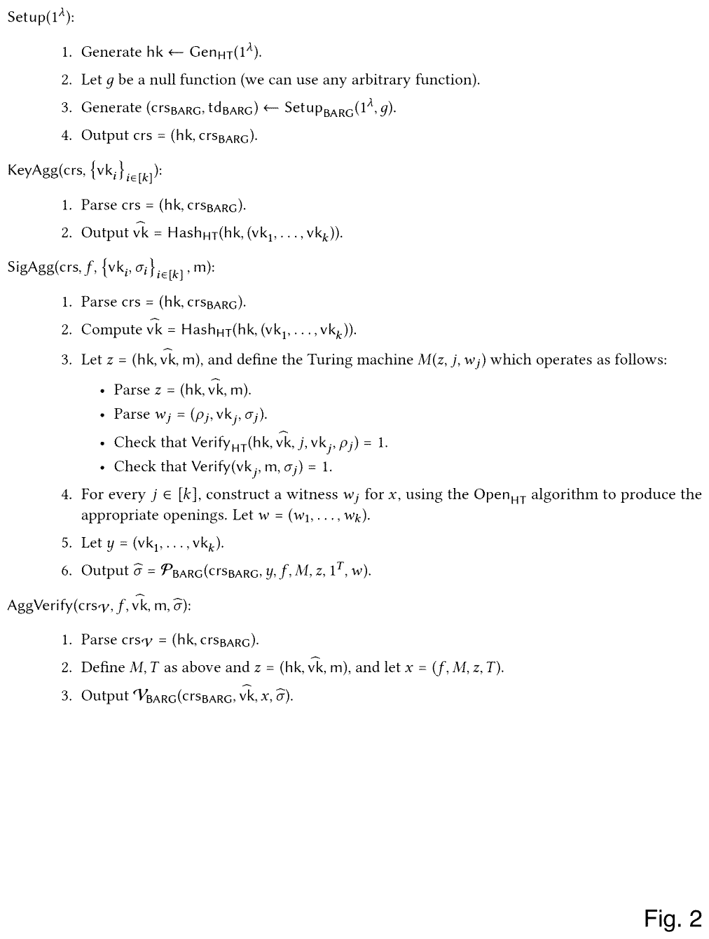

FIG. 2 presents a similar process for generating weakly unforgeable aggregate signatures for monotone circuits f. The main difference in this figure is the inclusion of a null function g in the Setup procedure, which may be used in the generation of the BARG parameters.

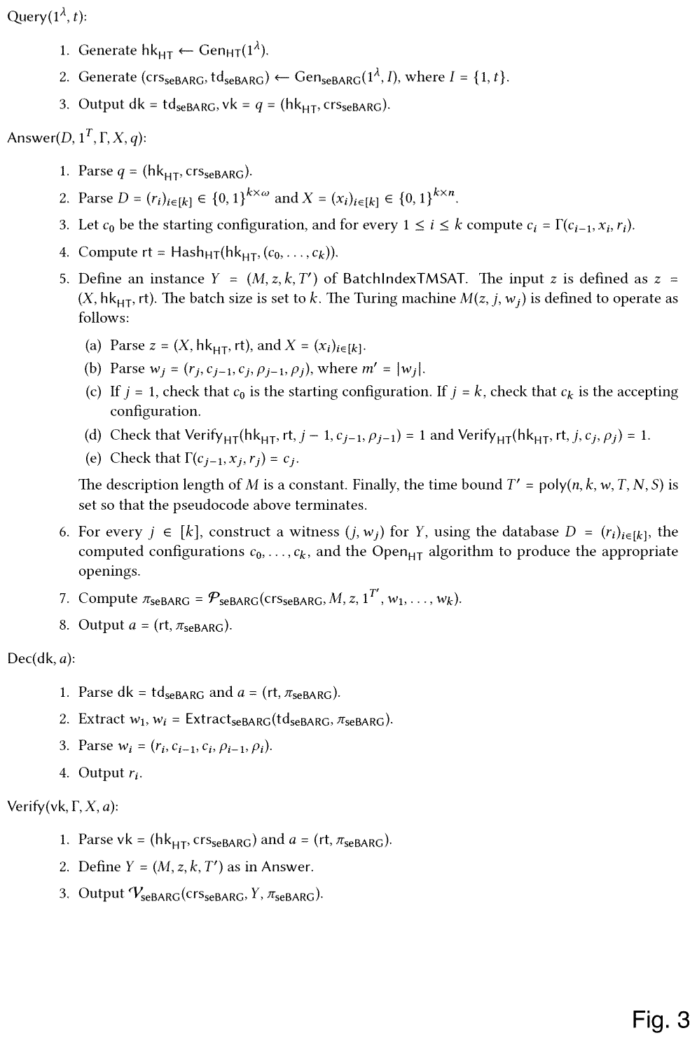

FIG. 3 illustrates the construction of a 2-composable verifiable private information retrieval (vPIR) scheme for policies. The Query function in this scheme may take inputs (1^{λ}, t) and produce outputs including a decryption key dk, a verification key vkᵢ and a query q. The function may generate a hash key hk_{HT} using Gen_{HT}(1^{λ}) and create a pair of parameters (crs_{seBARG}, td_{seBARG}) using Gen_{seBARG}(1^{λ}, I), where I is defined as {1, t}.

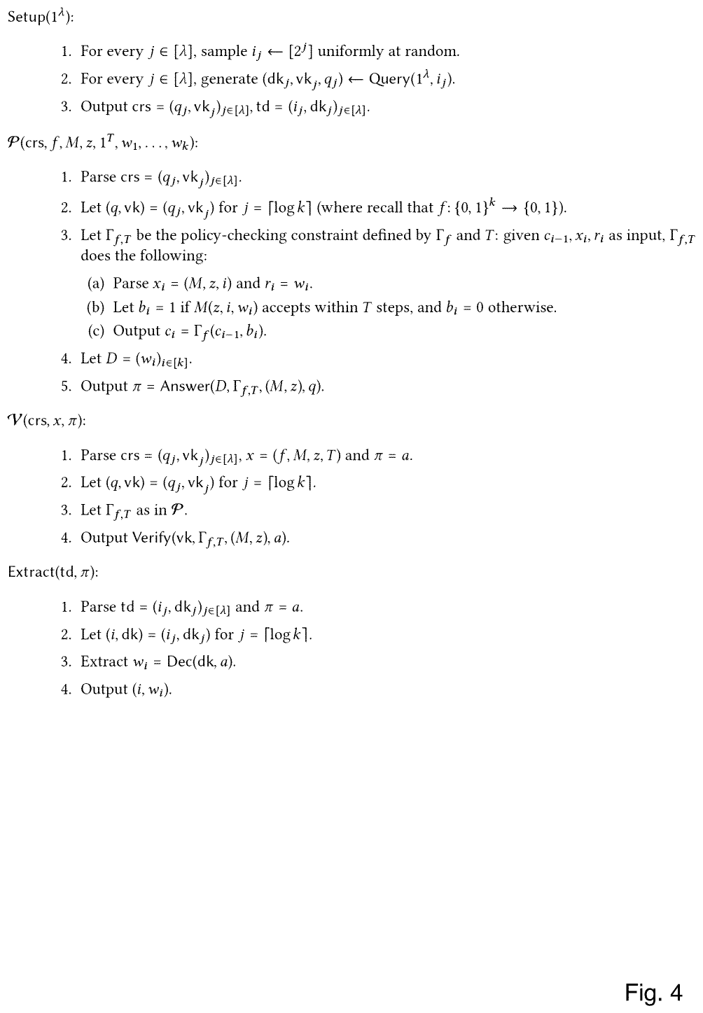

FIG. 4 depicts the construction of BARGs with adaptive subset extraction for bounded-space policies. The Setup procedure in this construction may sample indices iⱼ uniformly at random from [2^{j}] for every j∈[λ]. It may then generate parameters (dkⱼ, vkⱼ, qⱼ) using a Query operation. The output of this setup may include a common reference string crs=(qⱼ, vkⱼ)_{j∈[λ]} and a trapdoor td=(iⱼ, dkⱼ)_{j∈[λ]}.

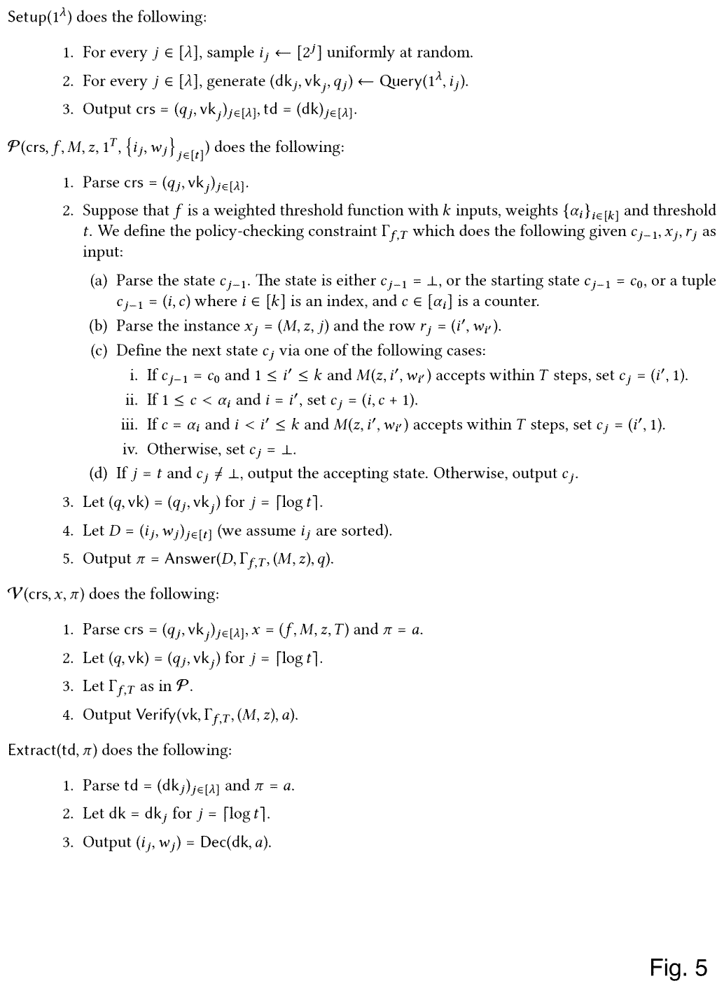

FIG. 5 shows a construction of sublinear prover BARGs for weighted threshold policies. This construction may be similar to the one in FIG. 4, but with additional steps in the prover procedure to handle weighted threshold functions.

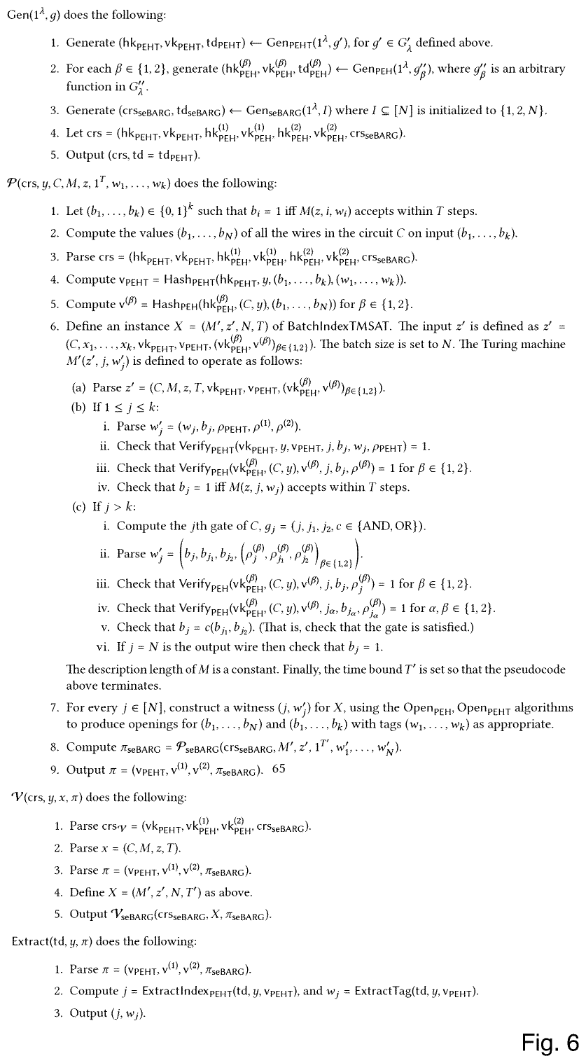

FIG. 6 illustrates the construction of BARGs with functional subset extraction. This construction may include procedures for generation (Gen), proving (P), verification (V), and extraction (Extract). The Gen procedure may generate parameters for predicate-extractable hash functions and batch arguments. The P procedure may compute bit values, generate hash values, and construct witnesses for verification. The V procedure may verify the cryptographic parameters, while the Extract procedure may process the proof to extract certain values.

In some cases, these constructions may provide a framework for generating and verifying aggregate signatures that support expressive monotone policies. The use of BARGs with adaptive subset extraction may allow for efficient verification of aggregate signatures while maintaining security against adaptive adversaries.

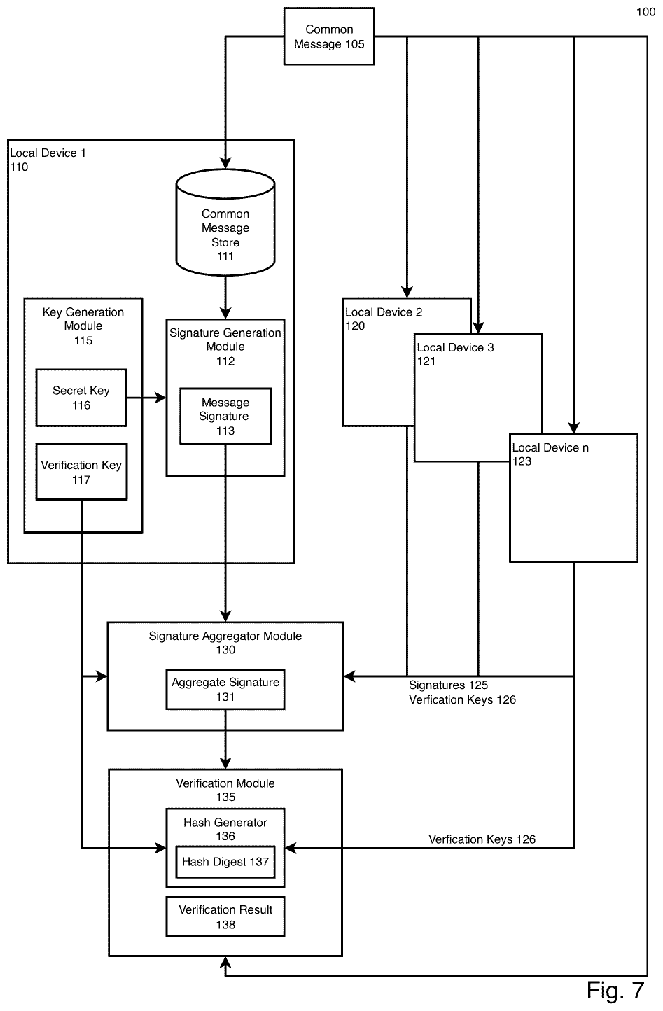

FIG. 7 illustrates an example system embodiment of an aggregate signature generation and verification apparatus 100.

At outset, a common message 105 is created by any means, and the common message can represent any arbitrary data for any arbitrary purpose. It is assumed that multiple local devices, including local device 1 110, local device 2 120, local device 3 121, and local device π 123 all have access to the common message 105.

At local device 1 110, a common message store 111 may be used to store common message 105.

Local device 1 110 can have access to a key generation module 115, which can be configured to generate a secret key 116 and verification key 117 pair. The local device 1 110 can have access to a signature generation module 112. Signature generation module 112 can be configured to sign the common message 105 stored in the common message store 111 using the key generation module 115 to generate a message signature 113.

Other local devices 120, 121, and 123 also generate signatures 125 which are transmitted to signature aggregator module 130. Signature aggregator module 130 can be configured to generate an aggregate signature 131 from the multiple signatures 113 and 125 that it has received. Joint and aggregate and used interchangeably herein.

At a verification module 135, verification key 117 from local device 1 110 is received, as is verification keys 126 from other local devices 120, 121, and 123. At a hash generator 136, a hash digest 137 is generated based on the received verification keys 117 and 126. The verification module 135 then generates a positive or negative verification result 138 based on the hash digest 137, common message 105, and the aggregate signature 131.

Some elements may be local, other elements may be remote, or distributed. The apparatus 100 may be implemented in various types of computer systems and software tools, including local, cloud-based, or distributed systems. The choice of implementation can depend on various factors, such as the specific requirements of the system, the performance requirements, and the security considerations.

In some aspects, the apparatus 100 includes a local device 1 110, which houses a common message store 111 for storing a common message 105. The local device 1 110 also includes a signature generation module 112 and a cryptographic module, which may be a local cryptographic module or a remote cryptographic module. The cryptographic module includes a local cryptographic module 115 that generates a secret cryptographic key 116 and a verification cryptographic key 117 for a user. The verification cryptographic key 117 is transmitted to a signature generation module, which may be a local signature generation module or a remote signature generation module.

The signature generation module 112 of the local device 1 110 generates a user signature 113 for the common message 105 using the secret cryptographic key 116 for the user. The user signature 113 is then transmitted to an aggregator module 130. The aggregator module 130 may be a local aggregator module or a remote aggregator module. The aggregator module 130 combines the user signature 113 for the common message 105 with other user signatures 125 for the common message 105 received from other users to generate an aggregate signature 131. The aggregate signature 131 is then transmitted to a verification module 135.

The verification module 135 may be a local verification module or a remote verification module. The verification module 135 utilizes a hash generator 136 to produce a hash digest 137 of verification keys 117 and 126. The verification module 135 produces a verification result 138, ensuring the integrity of the signed common message 105.

In some cases, the aggregate signatures are constructed from non-interactive batch arguments that support adaptive subset extraction for expressive monotone policies. These non-interactive batch arguments may be constructed from Verifiable Private Information Retrieval. In some aspects, an untrusted aggregator party combines the signatures of multiple parties into an aggregate signature to certify expressive monotone policies over the signatures. The constructions may be in the common reference string (CRS) model where the size of the CRS grows polylogarithmically with the number of signers. The size of the aggregate signature may be sublinear in the number of signers and the threshold number of signers and may depend on a security parameter. This approach allows for the aggregation of signatures from different parties into a compact form, while still maintaining the ability to verify the authenticity of the message. This can be particularly beneficial in scenarios where the number of signers is large, as it can reduce the computational and storage requirements associated with signature verification.

In some embodiments, the verification of the aggregate signature for the signed message is performed without knowing the identity of the signers. Various cryptographic signature schemes, as described herein, may be used in the aggregate signature generation and verification apparatus 100. The implementation of the aggregate signature generation and verification apparatus 100 may be done using different programming languages and libraries, such as Java, C, and Python. The public keys may be stored in a centralized repository, such as a Public Key Infrastructure (PIG), or in a decentralized system, such as a blockchain. A cryptographic hash function, as described herein, may be used in the aggregate signature generation and verification apparatus 100.

In some embodiments, a signature generation module 112 is used to generate a digital signature by encrypting the hash value of the message using the sender's private cryptographic key. The signed message is then transmitted to the recipient. A verification module 135 is used to verify the signature and a storage module is used to store the result of the aggregate signature verification.

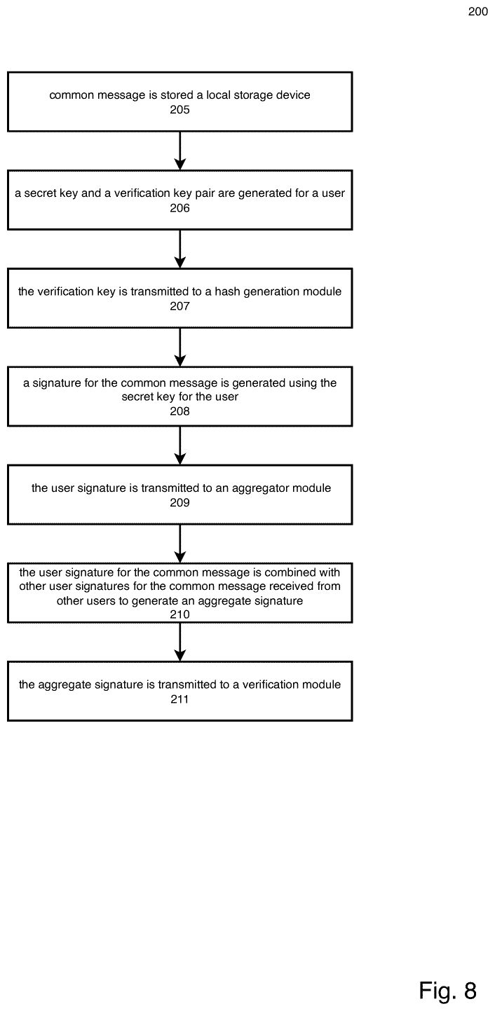

FIG. 8 illustrates an example embodiment of the aggregate signature generation method 200. A common message is stored a local storage device in step 205. At a local key generation module, a secret key and a verification key pair are generated for a user in step 206. In step 207, the verification key is transmitted to a hash generation module. In step 208, at a local signature generation module, a signature for the common message is generated using the secret key for the user.

In step 209, the user signature is transmitted to an aggregator module. In step 210, the user signature for the common message is combined with other user signatures for the common message received from other users to generate a aggregate signature. In step 211, the aggregate signature is transmitted to a verification module.

The method 200 may be implemented in various types of computer systems and software tools, including local, cloud-based, or distributed systems. The choice of implementation can depend on various factors, such as the specific requirements of the system, the performance requirements, and the security considerations.

In some aspects, the method 200 begins with a common message being stored in a local storage device during a message storage step 205. The common message may be any type of digital data, such as a text document, an image, a video, or a piece of software code. The common message may be stored in various types of storage devices, such as a hard disk, a solid-state drive, a flash memory, or a cloud storage service.

Following the message storage step 205, a secret cryptographic key and a verification cryptographic key pair for a user are generated during step 206. The cryptographic keys may be generated using various types of cryptographic algorithms, as described herein. The secret cryptographic key is used for generating digital signatures, while the verification cryptographic key is used for verifying digital signatures.

After the cryptographic keys are generated, the verification cryptographic key is transmitted to a hash generation module during a 207. The hash generation module may be a software module that is capable of generating cryptographic hash values from input data. The hash generation module may be implemented in various types of computer systems and software tools, including local, cloud-based, or distributed systems.

Subsequently, a signature for the common message is generated using the secret cryptographic hash function for the user during a signature generation step 208. The signature may be generated using various types of signature generation algorithms, as described herein. The signature is a digital code that is appended to the common message to verify the authenticity and integrity of the message.

Once the signature is generated, it is transmitted to an aggregator module during a signature transmission step 209. The aggregator module may be a software module that is capable of aggregating multiple signatures into a single aggregate signature. The aggregator module may be implemented in various types of computer systems and software tools, including local, cloud-based, or distributed systems.

In some cases, the aggregator module combines the user signature for the common message with other user signatures for the common message received from other users to generate a joint signature during an aggregate signature generation step 210. The number of user signatures that are combined may vary depending on the specific requirements of the system. In some cases, at least a threshold number of parties signed a message. In other cases, each party has a different weight and a signing policy is defined with respect to a sum of the party weights. The aggregation time may grow with the number of signatures and not the number of parties.

Finally, the joint signature is transmitted to a verification module during a verification transmission step 211. The verification module may be a software module that is capable of verifying the authenticity and integrity of the joint signature. The verification module may be implemented in various types of computer systems and software tools, including local, cloud-based, or distributed systems.

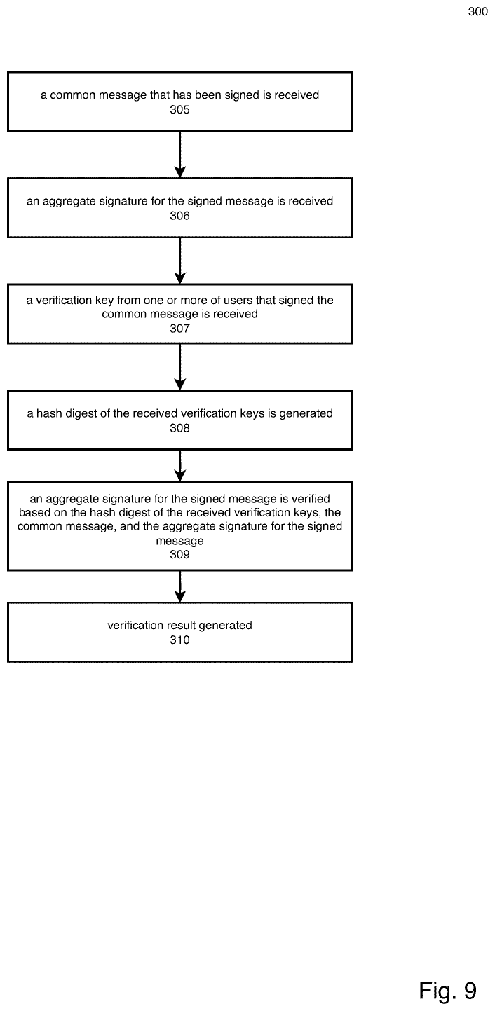

FIG. 9 illustrates an example embodiment of the aggregate signature verification method 300. A common message that has been signed is received at a local storage device in step 305. An aggregate signature for the signed message is received in step 306. A verification key from one or more of users that signed the common message is received in step 307. A hash digest of the received verification keys is generated in step 308. In step 309, an aggregate signature for the signed message is verified based on the hash digest of the received verification keys, the common message, and the aggregate signature for the signed message. In step 310, a verification result is generated and stored.

A flowchart 300 for a method of verifying an aggregate signature is depicted. The method may be implemented in various types of computer systems and software tools, including local, cloud-based, or distributed systems. The choice of implementation can depend on various factors, such as the specific requirements of the system, the performance requirements, and the security considerations.

In some aspects, the method begins with a signed message reception 305, which initiates the process by receiving a common message that has been signed by multiple users. The common message may be any type of digital data, such as a text document, an image, a video, or a piece of software code. The common message may be received from various types of sources, such as a local storage device, a remote server, or a network connection.

Following the signed message reception 305, an aggregate signature reception 306 receives an aggregate signature for the signed message. The aggregate signature may be a digital code that is appended to the common message to verify the authenticity and integrity of the message. The aggregate signature may be received from various types of sources, such as a local storage device, a remote server, or a network connection.

Subsequently, a verification cryptographic key reception 307 takes place, where a verification cryptographic key from one or more users who signed the common message is received. The verification cryptographic key may be a digital code that is used to verify the authenticity and integrity of the aggregate signature. The verification cryptographic key may be received from various types of sources, such as a local storage device, a remote server, or a network connection.

After the verification cryptographic key is received, a cryptographic hash function generation 308 generates a hash digest of the received verification cryptographic keys. The hash digest may be generated using various types of hash generation algorithms, as described herein.

The signature verification process 309 verifies the aggregate signature for the signed message based on the hash digest of the received verification cryptographic keys, the common message, and the aggregate signature for the signed message. The verification process may be performed using various types of verification algorithms, as described herein. In some cases, the verification of the aggregate signature is performed without knowing the identity of the signers.

Finally, a verification result output 310 generates the verification result, concluding the process. The verification result may be a digital code that indicates whether the aggregate signature is valid or not. The verification result may be stored in a local storage device, transmitted to a remote server, or displayed on a user interface.

In some embodiments, if all parties sign the same message, the verification time is sublinear in the threshold number of signers. This can improve the efficiency of the verification process, especially when the number of signers is large. In other cases, if a vector of messages has a succinct representation, the verification time is sublinear in the threshold number of signers. This can further improve the efficiency of the verification process, especially when the messages are large or complex.

A number of implementations are described herein. Nevertheless, it will be understood that various modifications may be made without departing from the spirit and scope of the disclosure. Accordingly, other implementations are within the scope of the following claims.

### 1 Introduction

Suppose that a group of parties wish to jointly sign a message m such that anyone can verify that a majority of the parties signed m. Such a scenario is commonplace in applications such as byzantine agreement, crypto wallets and many other settings involving decentralization of trust.

Consider the following notion of digital signatures that captures several properties desirable for such applications: each of the k parties locally computes and publishes a verification key for its preferred signature scheme and uses the corresponding secret key to sign messages. Later, an untrusted party called the “aggregator” can combine the signatures of multiple parties into a joint signature \hat{σ} to certify that at least t out of k parties signed a message. The combined signature a can be verified given a digest of all k verification keys and the vector of messages signed (but without knowing the identity of the t signers). The key requirement is succinctness:
The size of the aggregate signature should be sublinear in k and even t, and ideally only depend on the security parameter.
If all parties sign the same message (or, more generally, if the vector of messages has some succinct representation), the verification time should also be sublinear in t.
Ideally, the aggregation time should grow with the number of signatures t as opposed to the number of parties k.
   The security requirement is that no polynomial-time adversary that corrupts less than t parties in an adaptive manner should be able to create valid signatures.

This notion combines the best features of two central notions of multiparty signatures: threshold signatures and aggregate signatures. (In the literature, there are two distinct notions of signature schemes that support signature aggregation: multisignatures, where all parties sign the same message, and aggregate signatures, where parties may sign distinct messages. For simplicity of exposition, we use the terminology of aggregate signatures to refer to both settings.) Threshold signatures, widely used in the blockchain ecosystem, support threshold signing with succinct verification but require interactive protocols for key setup and (in most cases) signing. Aggregate signatures dispense with the necessity of interaction but can only attest that all k parties signed (i.e., they do not support threshold signing). Therefore, the above notion can be viewed as a threshold variant of aggregate signatures or as an ad-hoc variant of threshold signatures. To see the appeal of this notion, consider decentralized autonomous organizations (DAO) where members vote on proposals to make joint decisions on governance of assets. Threshold signatures are a natural cryptographic tool for implementing such voting; however, running an interactive key setup between all members is unrealistic. Our notion eliminates this barrier.

Monotone-Policy Aggregate Signatures. We can generalize the above notion to capture more expressive signing policies. For example, consider weighted thresholds, where each party has a different weight and the signing policy is defined with respect to the sum of the party weights. Such a policy is useful in proof-of-stake blockchains. Another example is threshold of thresholds capturing users with some hierarchical structure. In general, the signing policy might be described by a monotone function that takes as input a list of signers and decides whether they are authorized. We refer to this primitive as monotone-policy aggregate signatures.

It is not difficult to see that this primitive can be realized by combining standard signature schemes with (adaptively sound) succinct non-interactive arguments of knowledge (SNARKs) for NP. The aggregate signature σn a message m simply consists of a SNARK that proves the existence of valid signatures on m from an authorized set of signers. The succinctness property of the SNARK translates to the succinctness of aggregate signature. Sublinear verification time can be achieved by additionally relying on collision-resistant hash functions to compute verification key digests.

SNARKs for NP are currently only known based on heuristics or non-standard assumptions. Moreover, SNARK constructions with an explicit knowledge extractor are not known and are subject to strong barriers.

Signatures from Batch Arguments. Non-interactive batch arguments (BARGs) allow an efficient prover to compute a publicly verifiable proof of the validity of multiple NP statements, with size sublinear in the total witness length. If at least one statement is false, no polynomial-time adversary should be able to compute an accepting proof.

A recent sequence of works provided constructions of BARGs for NP in the common reference string (CRS) model from various standard assumptions including learning with errors (LWE), decisional linear assumption (DLIN) over pairing groups, and sub-exponential decisional Diffie Hellman (DDH). Notably, these works achieve a somewhere extraction property that guarantees (given a CRS “trapdoor”) efficient extraction of the witness of one statement in the batch from any accepting proof. This guarantee holds in the adaptive setting where the adversary can choose the NP statements as a function of the CRS. Using this property, recent works obtained the first constructions of aggregate signatures from standard assumptions.

It is easy to see that there is a direct correspondence between the k-out-of-k (i.e., conjunction) policies supported by BARGs and aggregate signatures. In light of this connection, and towards answering the above question, we ask whether there exist batch arguments that support more expressive policies of the following form: given a batch of statements (x₁, . . . , xₖ) and a monotone policy f: {0, 1}^{k}→{0, 1}, a valid proof should attest whether f(b₁, . . . , bₖ)=1, where bᵢ indicates the veracity of xᵢ.

A very recent work investigates this problem for the setting where the policy f is described by a polynomial-size monotone circuit. They achieve an extraction property that extends the prior notion of somewhere extraction to general monotone policies. However, as we discuss in Section 2, this guarantee turns out to be inadequate for achieving monotone-policy aggregate signatures.

### 1.1 Our Results

We present the first constructions of aggregate signatures from standard assumptions that support expressive monotone policies and achieve poly-logarithmic signature size and verification time. Our constructions are in the common reference string (CRS) model where the size of the CRS grows only poly-logarithmically in the number of signers.

Before we state our results, we elaborate on our notion of aggregate signatures for monotone policies.

Monotone-Policy Aggregate Signatures. In an aggregate signature scheme for a monotone policy f, each party Pᵢ publishes its own verification key vkᵢ, and there is a deterministic public algorithm that aggregates the verification keys of all k parties into a single aggregated verification key [symbol] . Given a collection of signatures {σᵢ}_{i∈I} on a message m, an aggregator can produce an aggregated signature \hat{σ} on m. The signature \hat{σ} verifies with respect to [symbol] if f(b₁, . . . , bₖ)=1, where bⱼ=1 for every j such that signature σⱼ verifies with respect to vkⱼ.

In terms of security, we require that no efficient adversary can win the following game with non-negligible probability. The adversary may ask the challenger for the verification key of any party, and it can ask for a signature σn any message under any of these verification keys. These queries can be completely adaptive. Finally, the adversary produces a sequence of verification keys vk₁, . . . , vkₖ that may include keys that were not generated by the challenger. Intuitively, we think of the keys generated by the challenger as belonging to honest parties while the other keys come from parties corrupted by the adversary. Together with the verification keys, the adversary also produces a target message m and a signature \hat{σ}. The adversary wins if \hat{σ} verifies with respect to m and the key [symbol] aggregated from vk₁, . . . , vkₖ, and if the forgery is non-trivial. Intuitively, the forgery is non-trivial if the set of honest parties that signed m together with all corrupted parties does not satisfy the policy. That is, f(b₁, . . . , bₖ)=0 where bⱼ=1 for every j such that either the adversary asked for signature σn m with respect to vkⱼ, or vkₖ was not generated by the challenger.

Aggregate Signatures for Bounded-Space Monotone Policies. Our first construction supports read-once, bounded-space monotone policies. Such policies are given by a monotone function f: {0, 1})^{k}→{0, 1} that is computable by an algorithm that reads each bit of the input once, and maintains a state of size S that is updated after reading each bit. This class of monotone policies includes, for example: the t-out-of-k threshold function with state of size S=log k, or the weighted threshold function for weights in [B] with state of size S=log kB.

Theorem 1.1 (Informal). Assuming the existence of somewhere extractable BARGs with 2^{S}-security, there exists an aggregate signature scheme for all read-once O(S) space polynomial-time monotone policies. The size of the CRS, the size of the aggregated signature, and the verification time are poly(log k, S, λ) where λ denotes the security parameter.

In particular, for k=poly(λ) and S=log(k) the theorem only requires BARGs with polynomial security.

Under the same assumptions as in Theorem 1.1, we can also construct aggregate signatures for monotone policies f that are computable by monotone circuits of fan-in two and log(λ)-depth (or more generally, d-depth under 2^{d}-secure BARGs). This result is incomparable to Theorem 1.1. We refer the reader to Section 9 for further details.

Fast Aggregator. For threshold policies, our result in Theorem 1.1 can be extended to achieve a more efficient aggregator whose running time only depends on the number of signatures t as opposed to the total number of parties k.

Theorem 1.2 (Informal). Assuming the existence of somewhere extractable BARGs, there exist aggregate signature schemes for threshold policies such that the size of the CRS, the size of an aggregated signature and the verification time are poly(log k, λ), and the aggregation time is poly(t, λ) for threshold t.

Weakly Unforgeable Aggregate Signatures for Polynomial-Size Monotone Policies. Our last construction of aggregate signatures supports any policy computable by polynomial-size monotone circuits. It achieves the same (poly-logarithmic) CRS size, signature size and verification time as in Theorem 1.1 but satisfies a weaker notion of security. Intuitively, this notion only guarantees that the adversary cannot forge signatures on messages that were not signed by any honest party. This definition relaxes the fully adaptive definition discussed above as follows: in the security game, signing queries on the challenge message m under any verification key generated by the challenger are not allowed. (The adversary is still free to output its own verification keys.) A similar relaxation was studied in the context of threshold signatures where the stronger notion of full-security has proven to be more useful, but also more challenging to achieve.

Theorem 1.3 (Informal). Assuming fully homomorphic encryption and somewhere extractable BARGs, there exist weakly unforgeable aggregate signature schemes for all polynomial-size monotone circuits. The size of the CRS, the size of an aggregated signature and the verification time is poly(log k, λ).

Universal Aggregation and Updatability. We now highlight some additional properties of our constructions of aggregate signatures. First, our scheme supports universal aggregation: we allow each user to use a different signature without modifying the way that individual verification keys or signatures are generated. (For Theorem 1.3 the verification keys of the base signature are required to satisfy some natural property. See Section 5.4 for further details.) As a result, a signature issued by a party i can be reused for computing aggregate signatures with respect to different aggregate verification keys for different set of parties (that include i). Second, our schemes allow new users to dynamically join the system without the need to rerun system setup. The aggregate verification key defined for any subset of users can be efficiently updated to add new users. (The aggregated verification key in our scheme is simply a root of a hash tree computed over the individual verification keys.)

On Multi-hop Aggregation. Recently, prior work used rate-1 BARGs to construct multi-hop n-out-of-n aggregate signatures, where signatures can be aggregate incrementally. While, our schemes are only presented for the single-hop setting, we follow the same BARG based approach as that prior work. Therefore, it is plausible that similar ideas could be applied to our schemes to support multi-hop aggregation; we leave further exploration of this topic to future work.

Monotone-Policy Aggregate Signatures from Batch Arguments. Our aggregate signatures constructions are based on new notions of monotone-policy BARGs. To realize Theorem 1.1 we rely on monotone-policy BARGs with a new notion of security that we called adaptive subset extraction. Our definition models an adaptive adversary that given the CRS outputs a batch of k statements, a proof π and a necessary subset J for the monotone policy f. Here, we say that a subset J⊂[k] is necessary for f if for every input b₁, . . . , bₖ such that f(b₁, . . . , bₖ)=1, there exists a j∈J such that bⱼ=1. Our definition requires an efficient extractor algorithm that extracts from π a witness w such that conditioned on π being an accepting proof and J being a necessary subset, the extractor outputs a valid witness wⱼ for an index j∈J with probability at least 1/k. Since the extractor outputs a witness without knowing the set J, hitting J with probability 1/k is optimal. (For example in the case of k-out-of-k threshold, each singleton set {j} for j∈[k] is necessary.)

This notion is incomparable to the notion of subset extraction for monotone-policy BARGs from prior work. In their definition, the necessary subset J is chosen non-adaptively and programmed into the CRS, but the extraction algorithm is required to succeed with probability negligibly close to 1. Our construction of monotone-policy aggregate signatures crucially relies on the adaptive nature of our new security definition.

We construct BARGs with adaptive subset extraction for read-once bounded-space monotone policies.

Theorem 1.4 (Informal). Assuming the existence of somewhere extractable BARGs with 2^{S}-security, there exist BARGs with adaptive subset extraction for all read-once O(S) space polynomial-time monotone policies. The proofs are of size |w|·poly(log k, S, λ) and the CRS is of size poly(log k, λ), where λ denotes the security parameter and |w| is the length of a single witness.

We also give a variant of the BARGs in Theorem 1.4 where the running time of the prover grows with the number of witnesses it is given instead of the total number of statements k. This gives Theorem 1.2.

Finally, we realize Theorem 1.3 based on BARGs for monotone policies with a new notion of security called functional subset extraction which generalizes the notion of subset extraction from prior work. In BARGs with subset extraction, we program a necessary subset J into the CRS. In contrast, in functional subset extraction, we program a function g into the CRS. We also add a tag y that is given as an additional input to the BARG prover and verifier. The requirement is that given any proof π that is accepted with respect to a tag y, if J=g(y) is a necessary subset then we can extract from π a valid witness wⱼ for an index j∈J with probability negligibly close to 1.

Based on the construction of prior work, we obtain BARGs with functional subset extraction for all policies computable by polynomial-size monotone circuits. The proof is of size |w|·poly(log k, λ) where |w| is the size of a witness, and the CRS is of size B·poly(log k, λ), where B is abound on the description size of a function that can be programmed into the CRS.

### 1.2 Related Work

Threshold Signatures. There is an extensive body of work dedicated to the study of threshold signatures. The de facto design of such schemes involves a distributed setup phase to compute a verification key and a threshold secret sharing of the signing key. Subsequently, the parties can jointly sign messages using their key shares, typically using an interactive signing protocol.

While any signature scheme can be “thresholdized” using secure multiparty computation, prior work has primarily focused on designing efficient thresholdizers for popular signature schemes used in practice such as Schnorr, ECDSA and BLS. All such solutions, however, require interactive protocols for key setup and (except for BLS) signature computation. Furthermore, by their very design, such solutions do not support universal aggregation of signatures from different signature schemes. Very recently, prior work overcame the former limitation by presenting an efficient instantiation of the generic SNARK-based approach discussed earlier. The security of their schemes is proven in idealized models.

Aggregate Signatures. Aggregate signatures support aggregation of signatures from different parties on possibly different messages. The key requirement is succinctness of the aggregated signature. Most known schemes also support succinct verification given a digest of the verification key of all the signers. A variation of aggregate signatures where all signers sign the same message is referred to as multisignatures. For simplicity of exposition, we use the common terminology of aggregate signatures for both of these settings throughout this work.

Until recently, aggregate signatures were only known in the Random Oracle model from pairing-based assumptions (or only achieved weaker properties). Recently, using non-interactive BARGs, new constructions in the common reference string (CRS) model were obtained based on a variety of standard assumptions including LWE, DLIN assumption over pairing groups, and sub-exponential DDH.

Batch Arguments. Prior work gave the first construction of BARGs for NP from a non-standard but falsifiable assumption over bilinear maps. Recently, a sequence of works constructed BARGs for NP from a variety of standard assumptions with proof sizes ranging from slightly sublinear to poly-logarithmic in the number of statements. Two lines of work devised efficiency boosting compilers for BARGs: prior work shows how to achieve poly-logarithmic proof sizes generically from sublinear-size proofs, and other prior work constructs rate-1 BARGs from BARGs with low rate. Very recently, other prior work constructed BARGs for monotone circuits from polynomial hardness of LWE.

Sigma Protocols. Sigma protocols are three-round public-coin zero-knowledge proof systems with special soundness. They have many applications including efficient constructions of digital signatures via the Fiat-Shamir heuristic. Sigma protocols are known to be closed under different types of composition such as monotone span programs and more. In the composition of sigma protocols, the communication complexity typically grows with the number of instances and the primary emphasis is on preserving the zero knowledge property. In contrast, our focus is on succinctness and our signatures do not have any hiding property.

### 2 Technical Overview

In this section, we provide an overview of our definitions and constructions. Our starting point is a simple template construction of aggregate signatures from BARGs. By instantiating this template with existing BARG constructions, we get aggregate signatures for the k-out-of-k (i.e., conjunction) policy. In what follows, we instantiate the template construction with more general notions of BARGs resulting in aggregate signature for more expressive policies. We start by describing the template construction focusing on the simple case of conjunctions.

Template Aggregate Signature from BARGs. The CRS of the aggregate signature scheme consists of a CRS for the BARG and a description of a collision-resistant hash function H. Fix a base signature scheme S that is used by each party to generate keys and sign/verify messages. To aggregate a sequence of verification keys vk₁, . . . , vkₖ we compute a hash tree over them using H and set the aggregate verification key [symbol] to its root. An aggregate signature \hat{σ} on a message m under [symbol] is a BARG proof that m has a signature under each of the verification keys. In more detail, let [symbol] be the NP language that contains tuples ( [symbol] , m, i) if and only if there exists a verification key vkᵢ, a path authenticating vkᵢ as the i-th leaf of the hash tree rooted at [symbol] , and a valid signature σᵢ on m under vkᵢ using the base scheme S. Given verification keys vk₁, . . . , vkₖ, a message m and signatures σ₁, . . . , σₖ, we set the aggregate signature \hat{σ} to be a BARG proof for the k statements ( [symbol] , m, i)∈ [symbol] for i∈[k]. To verify the aggregate signature we simply verify that the BARG proof is accepting.

The succinctness of this construction follows from that of the hash tree and the BARG. The size of the aggregate verification key (i.e. the root of the hash tree) is poly(λ) where λ is the security parameter. By the succinctness of the BARG, the size of the aggregate signature (i.e. the BARG proof) is polynomial in λ and the size of the witness for a single statement ( [symbol] , m, i)∈ [symbol] . The witness consists of a key and signature σf the base scheme S and an authentication path in the hash tree and it is, therefore, of size poly(λ, log k). To get efficient verification we rely on BARGs with efficient verification known as BARGs for the index language. In such BARGs, verifying the k statements that differ from each other only in the index i∈[k] takes time that is polynomial in the size of just one statement and the proof. Therefore, verifying the k statements ( [symbol] , m, i)∈ [symbol] for i∈[k], takes time poly(λ, log k).

To show the security of the construction, consider an adversary A that outputs verification keys vk₁, . . . , vkₖ, a message m, and an aggregate signature \hat{σ} such that \hat{σ} is a valid signature σn m under the aggregate key [symbol] and there exists at least one index j*∈[k] such that the challenger generated the key vk_{j*} and did not sign m under vk_{j*}. Our goal is to give a reduction that can extract from the aggregate signature \hat{σ}(i.e. the BARG proof) a forged signature σn m under vkⱼ (or, alternatively, a collision in H). This seems to call for BARGs that are not only sound, but also extractable (i.e. BARGs of knowledge). Moreover, the BARGs should be adaptively secure since the statements depend on [symbol] , m which A may choose as a function of the CRS.

Existing BARG constructions, however, are not known to satisfy full-fledged knowledge soundness in the adaptive setting. Indeed, such BARGs would imply SNARKs for all of NP. Instead, existing BARGs provide a weaker guarantee known as somewhere extractability. In a somewhere extractable BARG we can generate, for every index j∈[k], a CRS that is “programmed” at j and is computationally indistinguishable from an honestly generated CRS. Under the programmed CRS, we can extract a witness for the j-th statement from any accepting BARG proof using a trapdoor. Using somewhere extractable BARGs, the security reduction for the aggregate signature is as follows. The reduction generates a CRS for the BARG that is programmed at a random index j∈[k]. If A produces a valid aggregate signature \hat{σ}(i.e. an accepting BARG proof) the reduction extracts a witness for the j-th statement ( [symbol] , m, j)∈ [symbol] . Such a witness contains a verification key [symbol] ⱼ, a path authenticating \tilde{v}kⱼ under [symbol] , and a valid signature σⱼ on m under \tilde{v}kⱼ. If \tilde{v}kⱼ≠vkⱼ the reduction finds a collision in H. Otherwise, if j=j*, the reduction finds a forged signature σn m under vk_{j*}. It remains to show that indeed j=j* with noticeable probability. This follows from the fact that the programmed CRS hides the index j. (Note that the reduction finds j* efficiently and without the CRS trapdoor).

Towards More Expressive Policies. Going beyond conjunctions, we turn our attention to aggregate signatures for more expressive monotone policies. Before describing our schemes, we start with a simple construction of an aggregate signature scheme for general monotone policies, albeit, with weak succinctness. The high-level idea is to use the aggregate signature scheme for conjunctions described above and restrict it to the subset of the parties that signed the message. In more detail, given verification keys vk₁, . . . , vkₖ we again set the aggregate verification key [symbol] to be the root of the hash tree over the k keys. Let {σᵢ}_{i∈I} be a collection of signatures on a message m by a subset of the parties I⊆[k] that satisfies the policy f. We aggregate {σᵢ}_{i∈I} into a signature \hat{σ} under [symbol] as follows. First, we use the conjunction scheme to aggregate {vkᵢ}_{i∈I} into an key [symbol] _{I} and aggregate {σᵢ}_{i∈I} into a signature \hat{σ}_{I} under [symbol] _{I}. The aggregate signature \hat{σ} contains contains a description of the set I, the keys {vkᵢ}_{i∈I} together with their authentication paths under [symbol] , and the signature \hat{σ}_{I}. To verify \hat{σ} under [symbol] we first check that the set I satisfies the policy and that all the authentication paths are valid. Then we use the conjunction scheme to recompute the aggregate key [symbol] _{I} and verify the signature \hat{σ}_{I}. The main drawback of this approach is that size of the aggregate signature \hat{σ} can grow with the size of the authorized subset I. For example, for the t-out-of-k threshold policy, the signature will grow with the threshold t. In contrast, our results give succinct aggregate signatures of size poly(log k, λ) even for policies where the authorized subsets may be much larger.

Aggregate Signatures from Monotone-Policy BARGs. Our aggregate signature constructions follow a different approach: starting from the template construction of aggregate signature, we replace the BARGs with the stronger notion of BARGs for monotone policies. Intuitively, a BARG for a monotone policy f, can prove that a batch of statements x₁, . . . , xₖ satisfies f. That is, f(b₁, . . . , bₖ)=1, where bᵢ indicates the veracity of xᵢ. Recall that in our template aggregate signature construction, a valid statement xᵢ corresponds to a signature under the i-th party's verification key. BARGs for all policies given by polynomial-size monotone circuits were constructed by a recent work of Brakerski, Brodsky, Kalai, Lombardi and Paneth, however, the security notion guaranteed by their BARGs seems insufficient to prove the security of the aggregate signatures. Instead, our results are based on new monotone-policy BARG constructions that satisfy different security notions. Before expanding on these contributions, we start by reviewing the security notion of prior work and explain why it is insufficient.

The prior work work puts forward a generalization of the somewhere extractability property of other prior work to the settings of monotone-policy BARGs: Instead of programming the CRS on a single index j∈[k], we can program the CRS on any necessary subset of indices J⊆[k] and the programmed CRS hides J. A subset J⊆[k] is necessary if any other subset J′ that satisfies the policy intersects J. Or, equivalently, J is necessary if its complement [k]\J does not satisfy the policy. (We assume that the policy is not a constant function.) Using the programmed CRS, we can extract from any accepting BARG proof, a witness for the j-th statement for some j∈J. This holds even if the adversary can choose the BARG statements x₁, . . . , xₖ∈ [symbol] adaptively, as a function of the CRS. For example, for the conjunction policy, every singleton set {j} for j∈[k] is necessary, and thus, we recover the original notion of somewhere extractability for BARGs.

We can instantiate the template aggregate signature construction with somewhere extractable monotone-policy BARGs, but we do not know how to argue the security of the resulting scheme. (Another issue is that in the construction of prior work the CRS size grows linearly with k, while we are aiming for CRS of size poly(λ, log k).) Going back to the aggregate signatures security game, consider an adversary A that is given a CRS, and, after interacting with the challenger, outputs verification keys vk₁, . . . , vkₖ, a target message m and an aggregate signature \hat{σ} on m that verifies under the aggregate key [symbol] . Let J⊆[k] be the subset of indices of honest parties that did not sign m. That is, J contains every index j such that the challenger generated vkⱼ but did not sign m under it. Recall that A's forgery is considered non-trivial if the set of honest parties that signed m together with all corrupted parties does not satisfy the policy. In other words, if A wins the game then J must be a necessary subset. Therefore, if we had programmed the CRS on the set J, we could have extracted from \hat{σ} (i.e. the BARG proof) a witness for the j-th BARG statement ( [symbol] , m, j)∈ [symbol] for some j∈J. Such a witness must contain a forged signature σⱼ on m under vkⱼ (or, a collision in the hash H) and, since j∈J, this is a non-trivial forgery of the base signature scheme S. The problem with this argument is that the necessary subset J is defined by A's queries and output and, therefore, it is not known at the time the CRS is generated. In fact, A can even choose J adaptively as a function of the CRS. (Note that if the policy has necessary subsets that are sufficiently large, then guessing the set J may result in security loss that is exponential in k. Tolerating such loss would mean losing succinctness.)

To get around this hurdle we introduce new notions of security of monotone-policy BARGs where the extraction guarantee holds for necessary subsets that can be chosen adaptively, after the CRS is fixed. The BARGs behind Theorems 1.1 and 1.3 are described in Sections 2.1 and 2.2 respectively.

### 2.1 Aggregate Signatures for Bounded-Space Monotone Policies

In this section we first describe our new notion of monotone-policy BARGs with adaptive subset extraction which is the main tool behind Theorem 1.1. Then we overview our construction of monotone-policy BARGs with adaptive subset extraction for the class of read-once, bounded-space monotone policies based on somewhere-extractable BARGs. A monotone policy f: {0, 1}^{k}→{0, 1} is read-once, space S if there exists a polynomial time Turing machine Γ and a pair of states s₀, sₖ∈{0, 1}^{S} such that f(b₁, . . . , bₖ)=1 if and only if there exist states s₁, . . . , sₖ₋₁∈{0, 1}^{S} such that sᵢ=Γ(sᵢ₋₁, bᵢ) for every i∈[k].

Monotone-Policy BARGs with Adaptive Subset Extraction. In BARGs with adaptive subset extraction the CRS is generated together with an extraction trapdoor. However, in contrast to the notion of somewhere extractability, the CRS is not programmed on any particular subset. Instead, the adversary outputs a description of a subset J*⊆[k] together with the statements x₁, . . . , xₖ∈ [symbol] and the proof, after receiving the CRS. Ideally, we would like to require that whenever J* is necessary and the proof is accepting, we can extract a witness for the j-th statement for some j∈J* using a trapdoor. However, this requirement seems too strong since it implies full-fledged knowledge soundness. (I.e. we can extract witnesses for i-th statement for any i∈I for some subset I that satisfies the policy. (To extract, start from the necessary subset J*=[k], run the extractor, and obtain a witness for the j-th statement for some j∈J*. Remove j from J* and repeat until J* is no longer necessary.)) Instead, we only require that if the adversary outputs a necessary subset J* and an accepting proof with some probability α, then we can extract a witness for the j-th statement for some j∈J* with probability that is at most negligibly smaller than α/k. We note that as long as we only extract a single witness from each proof, losing a factor of k in the extraction probability is inherent. Taking, for example, the conjunction policy, if the adversary outputs a necessary subset {j} for a random j∈[k], then the extracted witness fits the j-th statement with probability at most 1/k. (We can relax adaptive subset extraction by considering a different bound β≥1/k on the loss in the extraction probability. The notion remains meaningful for any inverse polynomial β and is still sufficient for constructing aggregate signatures.)

By instantiating the template aggregate signature construction with monotone-policy BARGs that satisfy adaptive subset extraction (instead of somewhere extraction), we can fix the flawed analysis above: Consider an adversary A that wins the aggregate signatures security game with some noticeable probability α. As before, we let J* be the subset that contains every index j such that the challenger generated vkⱼ but did not sign m under it. If A wins the game then the aggregate signature \hat{σ} is valid (i.e. the BARG proof is accepting) and the set J* is necessary. Therefore, we are guaranteed to extract a witness for the j-th BARG statement ( [symbol] , m, j)∈ [symbol] for some j∈J* with noticeable probability α/k−negl. Such a witness must contain a non-trivial forged signature σⱼ under vkⱼ (or, a collision in the hash H).

BARGs with Adaptive Subset Extraction For Low-depth Policies. Our first construction of BARGs with adaptive subset extraction is based on any somewhere extractable BARG, and it supports policies that are computable by monotone circuits of fan-in two and log(λ)-depth (or, more generally, d-depth under 2^{d}-secure BARGs). The prior work gives a simple construction of BARGs for such policies. We observe that their analysis naturally extends to show adaptive subset extraction. For completeness, we describe this construction and its analysis in Section 9. We note that the main construction from prior work that supports more expressive policies does not guarantee adaptive subset extraction out of the box.

On Adaptive Subset Extraction from Somewhere Extraction. A natural approach for constructing monotone-policy BARGs with adaptive subset extraction would be to start from any somewhere-extractable monotone-policy BARG and transform it into a BARG with adaptive subset extraction for the same policy. Indeed, for the conjunction policy such a transformation exists: simply program the CRS on a necessary subset {j} for a random j∈[k]. To argue that the resulting BARG satisfies adaptive subset extraction, consider an adversary that outputs a necessary subset J* and an accepting proof for some batch of statements with probability α. The somewhere extraction property guarantees that we can extract a witness for the j-th statement from any accepting proof. Moreover, since the CRS hides the index j, the probability of extracting a witness for the j-th statement for j∈J* is at least α/k−negl.

This transformation, however, does not seem to extend to other policies. Consider, for example, the (k−1)-out-of-k threshold policy where every set with more than one index is necessary. We focus on transformations where the CRS is programmed with a subset J sampled from some distribution over necessary subsets. Let A be an adversary that outputs a random subset J* of size exactly 2 together with an accepting proof. The somewhere extraction property guarantees that we can extract a witness for the j-th statement for some j∈J with probability 1−negl. Now, suppose that that whenever J\J* is not empty, the extracted index j is in J\J*. Indeed, we cannot rule out such an adversary since the extracted index j may depend both on the programmed set J and on A's proof (which may be correlated with J*). (We can even construct a contrived BARG for which this attack is feasible based on the scheme of prior work.) Since J is of size at least 2 and J* is a set of size exactly 2 chosen at random after J is already fixed, the probability that J\J* is empty is at most

$$\frac{2}{k ( k - 1 )} .$$

Therefore, j∈J* with probability that is noticeably smaller than 1/k. (More generally, if a policy f has exactly T “minimal” necessary subsets (that do not contain smaller necessary subsets) then we can transform any somewhere-extractable BARG for f into a BARG for f with adaptive subset extraction where the loss in extraction probability is bounded by β=1/T. However for β>1/T we do not know of such a transformation.)

Extracting at an Index Instead of a Subset. In the above attempt to transform somewhere extraction into adaptive subset extraction, the high level idea was to guess some necessary subset J and program it into the CRS. The problem is that we had no control over the statement in J for which we extract a witness. As a result, we had to guess a subset J that is entirely contained in the subset J* chosen by the adversary. For some policies, however, this loss in the probability of extraction is too high.

We therefore follow a different approach: instead of guessing a necessary subset J, we guess the particular index j∈[K] of the statement xⱼ we wish to extract a witness for, and program j into the CRS. Indeed, since j is hidden from the adversary, the probability that j∈J* is at least 1/k−negl. However, now we can no longer expect to extract a witness for the j-statement from any accepting proof. Unless the subset {j} happens to be necessary, the adversary might output statements x₁, . . . , xₖ∈ [symbol] where the subset I⊆[k] of true statements satisfies the policy, but xⱼ∈ [symbol] and so extraction must fail. Moreover, we cannot rule out an adversary that outputs such statements with probability 1, even when j is sampled randomly. The issue is that the adversary may choose the statements adaptively, as a function of the CRS, without knowing which of the statements are true.

A possible solution to this problem is to have the adversary prove that it knows the subset I of true statements. Indeed, if the adversary outputs a subset J* that is necessary, then J* and I intersect. Therefore, if the adversary knows I (i.e. we can efficiently extract I from the adversary) then we can use the fact that j is hidden to argue that, conditioned on J* being necessary, j∈J*∩I with probability at least 1/k−negl. The problem with this solution is without resorting to SNARKs for NP, we do not know how to prove knowledge of I without losing succinctness. Nonetheless, this approach turns out to be useful: instead of requiring the prover to know the subset I of true statements, in our solution we make a weaker requirement. Very roughly, we require that it is possible to simulate a subset I that satisfies the policy and is, in some useful sense, indistinguishable from the actual subset I of true statements chose by the adversary. We show how to enforce this weaker requirement using weaker machinery that can be based on BARGs.

Verifiable PIR. The main tool we use to construct monotone-policy BARGs with adaptive subset extraction is verifiable private information retrieval (vPIR) recently introduced by Ben-David, Kalai, and Paneth. In a plain PIR protocol a server holds a database D=(r₁, . . . , rₖ) and a client can query a row rᵢ while keeping the index i hidden from the server. Each party sends one message, and the size of the server's answer should be sublinear in k. In vPIR we additionally require the server to use a database that satisfies some predicate P. Otherwise, its answer should be rejected by the (public) verification algorithm. This security requirement is formalized via the real-ideal paradigm: for every efficient malicious server A we require that there exists an efficient simulator Sim such that for every index i the output of the following two experiments are indistinguishable: (The actual notion we work with is slightly weaker: for every polynomial q there exists a simulator Sim such that the outputs are 1/q-indistinguishable.)
Real: Query A on index i. If the answer verifies output the decrypted row r. Otherwise output ⊥.
Ideal: Sim samples a database D=(r₁, . . . , rₖ). If P(D)=1 output rᵢ. Otherwise output ⊥.

One may consider a stronger MPC-style notion where Sim is required to simulate also the view of A in the real experiment (i.e. the query). However, we do not know how to satisfy this stronger notion. The prior work constructs vPIR for read-once, log-space predicates based on somewhere-extractable BARGs. (More generally, they can handle read-once space S predicates based on 2^{S}-secure BARGs.) We say that a predicate P is read-once space S if there exists a polynomial time Turing machine Γ and a pair of states s₀, sₖ∈{0, 1}^{S} such that P(r₁, . . . , rₖ)=1 if and only if there exist states s₁, . . . , sₖ₋₁∈{0, 1}^{S} such that sᵢ=Γ(sᵢ₋₁, rᵢ) for every i∈[k].

Verifiable PIR for Policies. When constructing monotone-policy BARGs for a policy f, we use vPIR for particular predicates P_{f} that evaluates the policy f where the i-th input bit to the policy is computed by some local polynomial-time predicate L on the i-th database row. Moreover, it would be useful to allow the local predicate to depend on some row-specific instance. That is, given instances x₁, . . . , xₖ and a database D=(r₁, . . . , rₖ), we have P(D)=f(b₁, . . . , bₖ) where bᵢ=L(xᵢ, rᵢ) for every i∈[k]. Observe that if f is a read-once space S policy, then P_{f} is also a read-once space S predicate.

Looking ahead, the instances will correspond to the BARG statements x₁, . . . , xₖ∈ [symbol] and, therefore, when defining security, we need to allow the adversary choose these instances adaptively as a function of CRS. While the analysis of prior work only supports predicates that are chosen non-adaptively, we extend their construction and show that for predicates of form P_{f} it satisfies a useful notion of security in the adaptive setting. (To get BARGs for the index language, our vPIR construction additionally supports fast verification for instances x₁, . . . , xₖ that differ from each other only on the index i∈[k].) For every efficient malicious server A we require that there exists an efficient simulator Sim such that for every index i the output of the following two experiments are indistinguishable:
Real: Query A on index i and obtain instances (x₁, . . . , xₖ) and an answer a. If the answer verifies output (xᵢ, r) where r is the decryption of α. Otherwise output ⊥.
Ideal: Sim samples instances (\tilde{x}₁, . . . , \tilde{x}ₖ) and a database D=(r₁, . . . , rₖ). If P(D)=1 output (\tilde{x}ᵢ, rᵢ). Otherwise output ⊥.
   One may consider a stronger notion where Sim is required to simulate all the instances x₁ . . . , xₖ chosen by A in the real experiment instead of just xᵢ. However, we do not know how to satisfy this stronger notion. See Section 6 for further details on the notion and construction of vPIR for policies.

BARGs with Adaptive Subset Extraction from vPIR: First Attempt. We start with a simple construction of monotone-policy BARGs from vPIR. (We will eventually need to modify this construction to show adaptive subset extraction.)

To construct BARGs for a policy f we will use vPIR for a related predicate P_{f} over the database of witnesses: for statements x₁, . . . , xₖ, and database D=(w₁, . . . , wₖ) we have that P(D)=f(b₁, . . . , bₖ), where bᵢ=1 if and only if wᵢ is a valid witness for the i-th statement. The CRS of the BARG is a vPIR query for a random index j∈[k]. The prover computes the vPIR answer using the database of witnesses D=(w₁, . . . , wₖ) (if the prover is not given a witness for xᵢ it sets wᵢ=⊥) and outputs it as the proof. The verifier accepts the proof if the vPIR answer verifies. To extract a witness from the proof we decrypt the vPIR answer.

To explain the difficulty in proving adaptive subset extraction, consider the following (flawed) argument. Let A be an adversary that given a CRS (i.e. a vPIR query), outputs a statement x₁, . . . , xₖ, an accepting proof (i.e. a vPIR answer) and a necessary subset J* with probability α. By vPIR security, there is a simulator Sim that samples instances \tilde{x}₁, . . . , \tilde{x}ₖ and a database \tilde{D}=(\tilde{w}₁, . . . , \tilde{w}ₖ) such that P_{f}(D)=1 with probability α−negl. Moreover, if j is the random index queried in the CRS, then the output (\tilde{x}ⱼ, \tilde{w}ⱼ) of the ideal experiment is indistinguishable from the output (xⱼ, w) of the real experiment where w denotes the decrypted vPIR answer (this is conditioned on the outputs being different than ⊥). If P_{f}(\tilde{D})=1 then any necessary subset J* must contain some index i∈J* such that \tilde{w}ᵢ is a valid witness for \tilde{x}ᵢ∈ [symbol] . Since \tilde{D} is sampled independently of j we have that i=j with probability 1/k. That is, with probability at least α/k−negl, \tilde{w}ⱼ is a valid witness for \tilde{x}ᵢ∈ [symbol] and j∈J*. By vPIR security, it follows that also in the real experiment, the extracted value, w is a valid witness for xⱼ∈ [symbol] and j∈J* with probability at least α/k−negl. The problem is that, while this argument holds for any fixed necessary subset J*, it may fail if A chooses J* adaptively, as a function of the CRS (i.e. the vPIR query). Indeed, vPIR security does not guarantee simulation of both w and the view of A together.

A Simple Analysis for Threshold Policies. We start by describing an alternative analysis tailored to the case of threshold policies. The solution for general policies is more complex and we discuss it next. For the t-out-of-k threshold policy, if the simulated database \tilde{D}=(\tilde{w}₁, . . . , \tilde{w}ₖ) satisfies the predicate, then, since the index j is random and independent of \tilde{D}, we have that \tilde{w}ⱼ is a valid witness for \tilde{x}ⱼ∈ [symbol] with probability at least α·t/k. By vPIR security, it follows that also in the real experiment, w is a valid witness for xⱼ∈ [symbol] with probability at least α·t/k−negl. (Note that we can use vPIR security here since this event does not depend on the set J* or the view of A.) For the t-out-of-k threshold policy, every necessary subset is of size at least k−t+1. Therefore, in the real experiment, since A outputs a necessary subset J* and since the index j is random and hidden from A, we have that j∈J* with probability at least α·(k−t+1)/k−negl. Therefore, by the Union bound, w is a valid witness for xⱼ∈ [symbol] and j∈J* with probability at least α/k−negl.

Going Beyond Threshold Policies via Composable vPIR. The analysis above crucially relies on the symmetric structure of threshold policies and it does not seem to extend beyond that. As suggested by failed attempt above, to support general read-once bounded space polices, it is sufficient to simulate the witness w extracted from the proof together with the subset J* chosen by A. While we do not know if such simulation is possible, our new simulation strategy will take into account the subset J*. Very roughly, the main idea behind our simulation is to encode the set J* as another database, and simulate both databases together using the machinery of vPIR. To this end, we introduce a stronger notion of vPIR that remains secure under composition. Intuitively, in a t-composable vPIR protocol for predicates P¹, . . . , P^{t}, the same query can be answered using t different databases, where the i-th database is required to satisfy the predicate Pⁱ. To capture this, we modify the real and ideal experiments as follows:
Real: Query A on index i and obtain instances (x₁, . . . , xₖ) and t answers a¹, . . . , a^{t}. If all the answers verify output (xᵢ, r¹, . . . , r^{t}) where r^{j} is the decryption of a^{j}. Otherwise output ⊥.
Ideal: Sim samples instances (\tilde{x}ᵢ, . . . , \tilde{x}ₖ) and t databases D¹, . . . , D^{t} where Dⁱ=(r₁^{j}, . . . , rₖ^{j}). If P^{j}(D^{j})=1 for every j∈[t] output (\tilde{x}ᵢ, rᵢ¹, . . . , rᵢ^{t}). Otherwise output ⊥.
   We show that the vPIR construction of prior work is t-composable for any t=O(1). Very roughly, what enables such composition is that evaluating read-once S space predicates over O(1) different databases can be done by a singe read-once O(S) space predicate operating over all the databases simultaneously. See Section 6 for further details on our composition theorem.

BARGs with Adaptive Subset Extraction from Composable vPIR. Our final construction of BARGs from vPIR remains unchanged, except that in the analysis we rely on the fact that the vPIR is 2-composable. To argue adaptive subset extraction, consider an adversary A against the BARG that given a CRS (i.e. a vPIR query) outputs statement x₁, . . . , xₖ, a proof (i.e. a vPIR answer a) and a subset J*. We turn A into a 2-composable vPIR adversary A′ that outputs the instances x₁, . . . , xₖ, A's vPIR answer a and an additional answer a′ that encodes J* as follows: Let D′=(b₁′, . . . , bₖ′) be the database such that bᵢ′=1 if and only if i∈J*. Let P_{f}′ be the predicate such that P_{f}′(D′)=1 if and only if f(D′)=0 (i.e. if and only if J* is necessary). Using vPIR for the predicate P_{f}′, compute the answer a′ to the query in the CRS from the database D′.

Say A outputs an accepting proof and a necessary subset J* with probability α. When this occurs, A′ outputs two accepting vPIR answers. Therefore, by 2-composable vPIR security, there is a simulator Sim that samples instances \tilde{x}₁, . . . , \tilde{x}ₖ and a pair of databases \tilde{D}=(\tilde{w}₁, . . . , \tilde{w}ₖ) and \tilde{D}′=(\tilde{b}₁′, . . . , \tilde{b}ₖ′) such that P_{f}(\tilde{D})=1 and P_{f}′(\tilde{D}′)=1 with probability α−negl. Moreover, if j is the random index queried in the CRS, then the output (\tilde{x}ⱼ, \tilde{w}ⱼ, \tilde{b}ⱼ′) of the ideal experiment is indistinguishable from the output (xⱼ, w₁, b′) of the real experiment where w and b′ denote the decryption of the answers α and α′ respectively (this is conditioned on the outputs being different than ⊥). If P_{f}(\tilde{D})=1 and P_{f}′(D′)=1 then there must exist some index i∈[k] such that \tilde{w}ᵢ is a valid witness for \tilde{x}ᵢ∈ [symbol] and \tilde{b}ᵢ′=0. Since \tilde{D}, \tilde{D}′ are sampled independently of j we have that i=j with probability 1/k. That is, with probability at least α/k−negl, \tilde{w}ⱼ is a valid witness for \tilde{x}ⱼ∈ [symbol] and \tilde{b}ⱼ′=0. By vPIR security, it follows that also in the real experiment, the extracted value, w is a valid witness for xⱼ∈ [symbol] and b′=0 with probability at least α/k−negl. Finally, by the definition of α′ (which was computed honestly) we have that b′=bⱼ′ and, therefore, w is a valid witness for xⱼ∈ [symbol] and j∈J* with probability at least α/k−negl.

Fast Prover/Aggregator. For general read-once bounded-space policies, the number of true statements required to satisfy the policy may be large. Therefore, the running time of the honest prover must, in general, grow with k. When constructing aggregate signatures from BARGs this affects the time required to aggregate signatures. However, for specific policies we can hope to do better. For example, for the t-out-of-k threshold policy, we construct a BARG with adaptive subset extraction where the prover time grows with t instead of k. Plugging this BARG into the template aggregate signature construction gives Theorem 1.2. Going beyond thresholds, the ideas behind our construction can be extended to give schemes with fast prover/aggregator for other policies as well. We discuss such extensions in Section 7.2.

We modify our construction of BARG from vPIR to use a more efficient encoding of the database of witnesses. In the scheme above the prover constructs a database with k rows where the witness for the i-th statement is stored in the i-th row, and the remaining rows contain ⊥. Instead, the prover constructs a database D with t rows such that each row contains a witness w and an index j∈[k] such that w is a valid witness for the j-th statement and, the sequence of t indices stored in the database is strictly increasing. Indeed, such a database exists if and only if at least t out of the k statements are true. Checking that the database satisfies these two properties can be done by a read-once predicate P using log k+1 bits of space. (The predicate can store the index of the last row read using log k bits and use another bit to remember if any of the previously read rows violated the constraints.)

The analysis of the new construction is similar to that above, with some key modifications. We again turn any adversary A against the BARG into a 2-composable vPIR adversary A′. When A outputs a vPIR answer a and a necessary subset J*, A′ outputs an additional answer a′ as above, however, α′ is computed in a different way: The answer a′ is computed from a database D′ using vPIR for a predicate P′ where D′, P′ are as follows: Let j̅ be a set of size t−1 such that J*∪J̅=[k] (such a set exists since J* is necessary). Let j₁, . . . , jₜ₋₁ be the indices in J̅ in increasing order. For i∈[t], the i-th row of D′ contains the pair of indices (jᵢ₋₁, jᵢ) where at the edges we set j₀=0 and jₜ=k+1. We can think of the row (jᵢ₋₁, jᵢ) as describing an open interval. The predicate P′ checks that the intervals in D′ are indeed ordered and cover all indices in [k] except for the t−1 end points in J̅. (Note that P′ is indeed a read-once log k+1 space predicate.) The key property that enables the analysis to go through is that in the ideal experiment, if the simulator samples a pair of databases \tilde{D}, \tilde{D}′ such that P(\tilde{D})=1 and P′(\tilde{D}′)=1 then there must exist some index i∈[t] such that if the i-th rows of \tilde{D}, and \tilde{D}′ are (\tilde{w}, \tilde{j}) and (\tilde{j}ᵢ₋₁, \tilde{j}ᵢ) respectively, then \tilde{w} is a valid witness for the \tilde{j}-th statement and \tilde{j}ᵢ₋₁<\tilde{j}<\tilde{j}ᵢ. Intuitively, the latter guarantees that in the real world, the extracted index j is outside the set \tilde{J} (and therefore, inside J*) with sufficiently high probability. See Section 7 for further details.

### 2.2 Weakly Unforgeable Aggregate Signatures for Polynomial-Size Monotone Policies

In this section we overview the proof of Theorem 1.3 for constructing aggregate signatures for all monotone policies given by polynomial-size circuits with weakly unforgeable security. Recall that in the aggregate signatures security game, the adversary outputs verification keys vk₁, . . . , vkₖ, a target message m and a signature \hat{σ}. The adversary wins if \hat{σ} is a valid signature σn m under the aggregate key and if the forgery is non-trivial. In the case of weakly unforgeable security, the forgery is considered non-trivial if the set of corrupted parties, whose keys where not generated by the challenger, does not satisfy the policy, and if no honest party signed m. (This is in contrast to the fully adaptive notion where honest parties are allowed to sign m, but the set of honest parties that signed m together with all corrupted parties should not satisfy the policy.)

Our construction is, once again, based on the template aggregate signature construction instantiated with a new notion of monotone-policy BARGs. To motivate this new notion we briefly recall our previous attempts: in a nutshell, our proof strategy was to define a necessary subset of indices J* based on the adversary's queries and then try to extract a witness for the j-th BARG statement for some j∈J*. Since J* was only fixed at the time the adversary outputs its forgery, we could not program J* into the CRS. Instead, we relied on the stronger notion of adaptive subset extraction where the subset J* can be chosen by the adversary, as a function of the CRS. Our construction of BARGs with adaptive subset extraction, however, is limited to read-once bounded space policies.

The main idea behind our construction in Theorem 1.3 is to fix the subset J* as a function of the BARG statements. This will allow us to target J* not only during extraction, but already in the construction and verification of the BARG proof. In more detail, in the weakly unforgeable aggregate signatures security game, the subset J* contains the indices of all honest parties whose verification keys were generated by the challenger. (This is in contrast to the fully adaptive notion where J* does not contain indices of honest parties that signed m.) Therefore, to recover the subset J* from the BARG statements (i.e. the verification keys vk₁, . . . , vkₖ) it is sufficient to distinguish keys generated by the challenger from keys generated by the adversary. To this end, we rely on an underlying signature scheme that supports trapdoor keys. In such a signature scheme, it is possible to generate “marked” verification keys that can be recognized using a trapdoor. Without the trapdoor, however, the adversary cannot distinguish the marked keys from honestly generated keys, or generate new marked keys. (Starting from any signature scheme, we can construct a scheme with trapdoor keys by adding a random string to each verification key. To mark a key, we replace the random string with a PRF-based MAC.)

To implement this idea, we instantiate the template aggregate signature construction with a new notion of monotone-policy BARGs with functional subset extraction that generalise the somewhere extraction property. A construction satisfying this notion is implicit in prior work. Recall that in BARGs with somewhere extraction, if we program the CRS on a necessary subset J, then, using a trapdoor, we can extract a witness for the j-th statement for some j∈J from any accepting proof. In functional subset extraction, the subset J depends both on the programmed CRS and on an additional input that is fixed together with the BARG statements. In more detail, the CRS is programmed with a function g and it is indistinguishable from an honestly generated CRS. (The length of the CRS grows with an upper bound on the description of g.) The BARG prover and verifier take an additional input y. The guarantee is that if J=g(y) is a necessary subset, then we can extract a witness for the j-th statement for some j∈J from any accepting proof using a trapdoor. We additionally require that the verification time does not grow with the running time of g. Moreover, in case the input y is itself long, the verifier only requires a short digest of y and its running time does not grow with |y|.

We plug in BARGs with functional subset extraction into the template aggregate signature construction. To aggregate a signature under a sequence of verification keys vk₁, . . . , vkₖ, we use this sequence as the input y to the BARG prover. We also include a short digest (a hash root) of y in the aggregate verification key, and the BARG verifier uses this digest to verify an aggregate signature. In the analysis, we consider an alternative challenger that gives the adversary marked verification keys, and programs the CRS with a function g that is hard-coded with the trapdoor for the base signature. Given an input y=(vk₁, . . . , vkₖ), g uses the trapdoor to recognize the marked keys and outputs the subset J containing their indices. We note that this analysis does not extend to the fully adaptive setting. In the fully adaptive security game, the adversary can ask the challenger to sign the target message m under some of the marked verification keys. In this case, the indices of these keys should not be included in the subset J, or we may extract a trivial forgery. In our weakly unforgeable construction, however, the subset J is fixed only as a function of the verification keys chosen by the adversary, regardless of its signing queries.

Our construction of monotone-policy BARGs with functional subset extraction is based on the somewhere extractable BARGs for monotone policies given by polynomial-size circuits from prior work. In their construction, the CRS contains the programmed subset J encrypted with a fully homomorphic encryption scheme. Therefore, given an input y and a CRS that contains an encryption of a function g, the prover homomorphically evaluates a CRS that is programmed on g(y) and computes its BRAG proof with respect to the evaluated CRS. The verifier given the input y can recompute the evaluated CRS itself and verify the proof. To allow verification given only the hash of y and to reduce the verification time to be independent of the running time of g, we use a RAM SNARK for deterministic computation to delegate the computation of the evaluated CRS to the prover.

### 3 Preliminaries

Notations. We use PPT to denote probabilistic polynomial-time, and denote the set of all positive integers up to n as [n]:={1, . . . , n}. For any x∈{0, 1}ⁿ and any subset J⊆[n] we denote by x_{J}=(xⱼ)_{jEj}. For any finite set S, x←S denotes a uniformly random element x from the set S. Similarly, for any distribution [symbol] , x← [symbol] denotes an element x drawn from the distribution [symbol] . We will also use the notation [symbol] _{[k]\J} often to denote a vector in {0, 1}^{k} such that the i-th position is 0 if and only if i∈J.

The universal language. Let [symbol] _{U} be the language of all triplets (Γ, x, y, T) such that Γ is a description of a Turing machine that on input x outputs y in T steps. We write (Γ, x, T)∈ [symbol] _{U} as a shorthand for (Γ, x, 1, T)∈ [symbol] _{U}, i.e., Γ accepts x in T steps.

### 3.1 Digital Signatures

In this section we define (standard) digital signatures.

Syntax. A digital signature scheme consists of the following polynomial-time algorithms:
KeyGen(1^{λ})→(sk, vk). This is a probabilistic algorithm that takes as input the security parameter 1^{λ}. It outputs a signing key sk and a verification key vk.
Sign(sk, m)→σ. This is a probabilistic algorithm that takes as input the signing key sk and a message m∈{0, 1}^{λ}. It outputs a signature \hat{σ}.
Verify(vk, m, σ)→0/1. This is a deterministic algorithm that takes as input the verification key vk, a message m∈{0, 1}^{λ} and a signature σ. It outputs a bit (1 to accept, 0 to reject).

Definition 3.1. A digital signature scheme (KeyGen, Sign, Verify) is required to satisfy the following properties:
Correctness. For any λ∈ [symbol] and m∈{0, 1}^{λ}

$$Pr [ Verify ( vk , m , σ ) = 1 : \begin{matrix}( sk , vk ) ← KeyGen ( {1}^{λ} ) \\ σ ← Sign ( sk , m )\end{matrix} ] = 1.$$

Unforgeability. For any admissible poly-size adversary [symbol] , there exists a negligible function negl such that for all λ∈ [symbol] ,

$$Pr [ Verify ( vk , {m}^{*} , {σ}^{*} ) = 1 : \begin{matrix}( sk , vk ) ← KeyGen ( {1}^{λ} ) \\ ( {m}^{*} , {σ}^{*} ) ← {𝒜}^{Sign ( sk , \cdot )} ( {1}^{λ} , vk )\end{matrix} ] \leq negl ( λ ) ,$$

where we say that [symbol] is admissible if it did not query the Sign(sk, ·) oracle with m*.

Remark 3.1 (Message space). We assume that the message space is {0, 1}^{λ}. This is without loss of generality, since we can sign arbitrary messages by first applying a hash function (that satisfies targeted collision resistance), then signing the hashed message.

3.2 Hash Family with Local Opening

In this section we recall the definition of a hash family with local opening. (In what follows we use the notation HT to denote a hash family with local opening, where HT symbolizes a Hash Tree construction. We emphasize that we are not restricted to such a construction, and use this notation only to give the reader an example to have in mind.)

Syntax. A hash family (HT) with succinct local opening consists of the following algorithms:
Gen(1^{λ})→hk. This is a PPT algorithm that takes as input the security parameter 1^{λ} in unary and outputs a hash key hk.
Hash(hk, x)→rt. This is a deterministic poly-time algorithm that takes as input a hash key hk and an input x∈{0, 1}^{N} for N≥2^{λ}, and outputs a hash value rt.
Open(hk, x, j)→ρ. This is a deterministic poly-time algorithm that takes as input a hash key hk, an input x∈{0, 1}^{N} for N≥2^{λ}, and an index j∈[N], and outputs an opening ρ.
Verify(hk, r^{t}, j, b, ρ)→0/1. This is a deterministic poly-time algorithm that takes as input a hash key hk, a hash value rt, an index j∈[N], a bit b∈{0, 1} and an opening ρ. It outputs a bit (1 to accept, 0 to reject).

Definition 3.2. (Properties of HT) A HT family (Gen, Hash, Open, Verify) is required to satisfy the following properties.
Opening completeness. For any λ∈ [symbol] , any N≥2^{λ}, any x∈{0, 1}^{N}, and any index j∈[N],

$$Pr [ Verify ( vk , rt , j , {x}_{j} , ρ ) = 1 : \begin{matrix}hk ← Gen ( {1}^{λ} ) , \\ rt = Hash ( hk , x ) , \\ ρ = Open ( hk , x , j )\end{matrix} ] = 1 - negl ( λ ) .$$

Succinctness. In the completeness experiment above, we have that |hk|+|rt|+|ρ|=poly(λ).
Collision resistance w.r.t. opening. For any poly-size adversary [symbol] there exists a negligible function negl(·) such that for every λ∈ [symbol] ,

$$Pr [ \begin{matrix}Verify ( hk , rt , j , 0 , {ρ}_{0} ) = 1 \\ ∧ Verify ( hk , rt , j , 1 , {ρ}_{1} ) = 1\end{matrix} : \begin{matrix}hk ← Gen ( {1}^{λ} ) , \\ ( rt , j , {ρ}_{0} , {ρ}_{1} ) ← 𝒜 ( hk )\end{matrix} ] = negl ( λ ) .$$

Remark 3.2. We say that a hash family with local opening is Λ-secure, for Λ=Λ(λ), if the collision resistance w.r.t. opening property holds against any poly(Λ)-size adversary (as opposed to poly(λ)-size) and the probability that the adversary finds a collision is negl(Λ) (as opposed to negl(λ)). We refer to this property as Λ-collision-resistance w.r.t. opening.

Theorem 3.3. Assuming the existence of a collision resistant hash family there exists a hash family with local opening (according to Definition 3.2).

3.3 Somewhere Extractable Batch Arguments (seBARGs)

A batch argument system BARG for an NP language [symbol] enables proving that k NP statements are true with communication cost that is polylogarithmic in k. There are many BARG variants which are known to be existentially equivalent under mild computational assumptions. In this work, for simplicity in our constructions, we make use of an argument system for “batch index Turing machine SAT” (BatchTMSAT), defined in prior work.

Definition 3.4. The language BatchIndexTMSAT consists of instances of the form x=(M, z, k, T), where:
M is the description of a Turing machine.
z is an input string (to M)
k is a batch size, and
T is a running time.
   An instance x=(M, z, k, T) is in BatchIndexTMSAT if for all 1≤i≤k, there exists a string wᵢ such that M(z, i, wᵢ) accepts within T steps.

We sometimes use the notation [symbol] (x, i, wᵢ) to denote the relation with instance (x, i) and corresponding witness wᵢ.

Syntax. A (publicly verifiable and non-interactive) somewhere extractable batch argument system seBARG for BatchIndexTMSAT consists of the following polynomial-time algorithms:
Gen(1^{λ}, i*)→(crs, td). This is a probabilistic algorithm that takes as input a security parameter 1^{λ}, and an index i*∈[2^{λ}]. It outputs a common reference string crs along with a trapdoor td.
[symbol] (crs, M, z, 1^{T}, w₁, . . . , wₖ)→π. This is a deterministic algorithm that takes as input a crs, Turing machine M, input z, runtime 1^{T}, and k witnesses w₁, . . . , wₖ. It outputs a proof π.
[symbol] (crs, x, π)→0/1. This is a deterministic algorithm that takes as input a crs, instance x=(M, z, k, T), and a proof π. It outputs a bit (1 to accept, 0 to reject).
Extract(td, π)→w. This is a deterministic algorithm that takes as input a trapdoor td and a proof π. It outputs a witness w.

Definition 3.5 (seBARG). A somewhere-extractable batch argument scheme se BARG=(Gen, [symbol] , [symbol] , Extract) for BatchIndexTMSAT is required to satisfy the following properties:
Completeness. For any λ∈ [symbol] , any k, n, m, T≤2^{λ}, any instance x=(M, z, k, T)∈BatchIndexTMSAT with |M|+|z|=n, any corresponding witnesses w₁, . . . , wₖ∈{0, 1}^{m} and any index i*∈[k],

$$Pr [ 𝒱 ( crs , x , π ) = 1 : \begin{matrix}( crs , td ) ← Gen ( {1}^{λ} , i \text{*)} , \\ π ← ( crs , M , 𝓏 , {1}^{T} , {w}_{1} , … , {w}_{k} )\end{matrix} ] = 1.$$

Efficiency. In the completeness experiment above, |crs|+|π|≤m·poly(λ). The running time of the verifier is at most poly(|crs|+|π|)+poly(λ). |x|.
Index hiding. For any poly-size adversary [symbol] , there exists a negligible function negl(·) such that for every λ∈ [symbol] and every pair of indices i₀, i₁∈[2^{λ}],

$$Pr [ ( crs ) = b : \begin{matrix}b ← \{ 0 , 1 \} , \\ ( crs , td ) ← Gen ( {1}^{λ} , {i}_{b} )\end{matrix} ] \leq \frac{1}{2} + negl ( λ ) .$$

Somewhere argument of knowledge. For any poly-size adversary [symbol] and any polynomials k(λ), T(λ) there exists a negligible function negl(·) such that for any index i*∈[k] and for every λ∈ [symbol] ,

$$Pr [ \begin{matrix}( crs , x , π ) = 1 \\ ∧ ( x , {i}^{*} , {w}^{*} ) ∉\end{matrix} : \begin{matrix}( crs , td ) ← Gen ( {1}^{λ} , {i}^{*} ) \\ ( M , z , π ) = ( crs ) \\ {w}^{*} ← Extract ( td , π ) \\ x = ( M , 𝓏 , k , T )\end{matrix} ] \leq negl ( λ ) .$$

Remark 3.3. We say that a seBARG scheme is Λ-secure, for Λ=Λ(λ), if the index hiding property and the somewhere argument of knowledge property hold w.r.t. a poly(Λ)-size adversary (as opposed to a poly(λ)-size), and the advantage probability is negl(Λ) (as opposed to negl(λ)). We refer to these properties as Λ-index-hiding and Λ-somewhere-argument-of-knowledge, respectively.

Remark 3.4. Given an se_{BARG}, one can naturally extend the definition of the key generation algorithm Gen to take as input an index set I⊂[k], as opposed to a single index. Gen(1^{λ}, I) will simply run Gen(1^{λ}, i) for every i∈I. The prover algorithm [symbol] , given a crs that encodes the |I| indices, will simply generate |I| proofs (one for each crs), and the verifier will check these |I| proofs independently.

Theorem 3.6. There exists a Λ-secure seBARG for BatchIndexTMSAT assuming Λ-hardness of LWE or DLIN.

### 4 Aggregate Signatures for Monotone Policies

In this section we define aggregate signature schemes for monotone policies. We additionally define a weaker notion, and define a special case of aggregate signatures where the prover time depends only on the number of instances for which it has witnesses.

Syntax. Let F={F_{λ} [symbol] be a family of monotone policies, such that each f∈F_{λ} is a monotone function f: {0, 1}^{k}→{0, 1}. Let S=(KeyGen, Sign, Verify) be a digital signature scheme. An F-aggregation scheme for S consists of the following polynomial-time algorithms:
Setup(1^{λ})→crs. This is a probabilistic setup algorithm that takes as input the security parameter 1^{λ}. It outputs a common reference string crs.
KeyAgg(crs, {vkᵢ}_{i∈[k]})→ [symbol] . This is a deterministic key aggregation algorithm that takes as input the common reference string crs, and a collection of verification keys {vkᵢ}_{i∈[k]}. It outputs an aggregate verification key [symbol] .
SigAgg(crs, f, {vkᵢ, σᵢ}_{i∈[k]}, m)→\hat{σ}. This is a deterministic signature aggregation algorithm that takes as input the common reference string crs, a policy f, a collection of verification keys and signatures {vkᵢ, σᵢ}_{i∈[k]}, and a message m. It outputs an aggregate signature \hat{σ}.
AggVerify(crs, f, [symbol] , m, \hat{σ})→0/1. This is a deterministic aggregate verification algorithm that takes as input the common reference string crs, a policy f, an aggregate verification key [symbol] , a message m, and an aggregate signature \hat{σ}. It outputs a bit (1 to accept, 0 to reject).

Definition 4.1 (Aggregation Scheme). An F-aggregation scheme (Setup, KeyAgg, SigAgg, AggVerify) for S=(KeyGen, Sign, Verify) is required to satisfy the following properties:
Correctness. For any λ∈ [symbol] , any policy f∈F_{λ}, any message m∈{0, 1}^{λ}, and any collection of verification keys and signatures {vkᵢ, σᵢ}_{i∈[k]} such that for bᵢ=Verify(vkᵢ, m, σᵢ) it holds that f(b₁, . . . , bₖ)=1,

$$Pr [ AggVerify ( crs , f , , m , \hat{σ} ) = 1 : \begin{matrix}crs ← Setup ( {1}^{λ} ) \\ ← KeyAgg ( crs , {\{ {vk}_{i} \}}_{i ∈ [ k ]} ) \\ \hat{σ} ← SigAgg ( crs , f , {\{ {vk}_{i} , {σ}_{i} \}}_{i ∈ [ k ]} , m )\end{matrix} ] = 1.$$

Efficiency. There exists a fixed polynomial poly such that in the correctness experiment above, | [symbol] |+|\hat{σ}|=poly(λ).
Unforgeability. For any λ∈ [symbol] and f∈F_{λ}, define the unforgeability game between an adversary [symbol] and a challenger as follows:
   The challenger samples crs←Setup(1^{λ}), and gives crs to [symbol] .
   The adversary can now make queries to the challenger. Each query is of one of two types:
      Verification key queries: [symbol] can request a verification key from the challenger. The challenger generates (sk, vk)←KeyGen(1^{λ}), gives vk to [symbol] and saves the pair (sk, vk).
      Signing queries: Given a verification key vk and a message m∈{0, 1}^{λ}, if the challenger previously saved the pair (sk, vk) it gives Sign(sk, m) to [symbol] . Otherwise, it gives ⊥.
   At the end of the game the adversary outputs a collection of verification keys {vkᵢ}_{i∈[k]}, a message m∈{0, 1}^{λ}, and an aggregate signature \hat{σ}.
   Let [symbol] =KeyAgg(crs, {vkᵢ}_{i∈[k]}. For i∈[k], let bᵢ=1 if [symbol] did not make a verification key query that was answered with vkᵢ (that is, if vkᵢ is a maliciously generated key), or if [symbol] made a signing query for vkᵢ, m. Otherwise, let bᵢ=0.
   The adversary [symbol] wins the game if f(b₁, . . . , bₖ)=0 and AggVerify(crs, f, [symbol] , m, \hat{σ})=1.
For any poly-size adversary [symbol] , there exists a negligible function negl(·) such that for all λ∈ [symbol] and f∈F_{λ}, [symbol] wins the unforgeability game with probability at most negl(λ).

We also consider a relaxed definition satisfying a weaker notion of unforgeability.

Definition 4.2 (Weakly Unforgeable Aggregation Scheme). A weakly unforgeable F-aggregation scheme (Setup, KeyAgg, SigAgg, AggVerify) for S is required to satisfy correctness and efficiency (as in Definition 4.1), and a weaker notion of unforgeability.

The weak unforgeability game is identical to the unforgeability game in Definition 4.1, except that to win the game, in addition to the condition specified in Definition 4.1, the adversary [symbol] may not make any signing query of the form (vkᵢ, m) for any i∈[k].

### 4.1 Fast Aggregation

In the notion of aggregation scheme as defined above, to compute an aggregated signature under an aggregated key [symbol] the signature aggregator must know all the verification keys aggregated in [symbol] . In what follows we formalize the notion of aggregation scheme with “sublinear” aggregation where the signature aggregator is only given a subset of the verification keys aggregated in [symbol] and signatures under the keys in this subset such that the subset satisfies the policy. In addition, for every verification key in the subset, the signature aggregator is also given a “proof” that the key is indeed one of the keys aggregated in [symbol] . For a signature aggregator that is given t signatures and verification keys, we want the aggregator run time to depend only on t.

Syntax. An F-aggregation scheme for S with fast aggregation contains polynomial-time key aggregation and signature aggregation algorithms with the following syntax (the syntax of the setup and aggregated verification algorithm is unchanged):
KeyAgg(crs, {vkᵢ}i∈[k])→( [symbol] , {ρᵢ}_{i∈[k]}). This is a deterministic key aggregation algorithm that takes as input the common reference string crs, and a collection of verification keys {vkᵢ}_{i∈[k]}.

It outputs an aggregate verification key [symbol] , and openings ρ₁, . . . , ρₖ.
SigAgg(crs, f, [symbol] , {vkᵢ, ρᵢ, σᵢ}_{i∈[t]}, m)→\hat{σ}. This is a deterministic signature aggregation algorithm that takes as input the common reference string crs, a policy f, the aggregate verification key [symbol] , a collection of verification keys, openings and signatures {vkᵢ, ρᵢ, σᵢ}_{i∈[t]}, and a message m. It outputs an aggregate signature \hat{σ}.

We modify Definition 4.1 to support the syntax above. In particular, the modified correctness property is as follows:
Correctness. For any λ∈ [symbol] , any k≤2^{λ}, any policy f∈F_{λ}, any message m∈{0, 1}^{λ}, any set S⊆[k] such that f [symbol] _{S})=1, and any collection of verification keys and signatures {vkᵢ, σᵢ} such that Verify(vkᵢ, m, σᵢ=1 for every i∈S,

$$Pr [ AggVerify ( crs , f , , m , \hat{σ} ) = 1 : \begin{matrix}crs ← Setup ( {1}^{λ} ) \\ ( , {\{ {ρ}_{i} \}}_{i ∈ [ k ]} ) ← KeyAgg ( crs , {\{ {vk}_{i} \}}_{i ∈ [ k ]} ) \\ \hat{σ} ← SigAgg ( crs , f , , {\{ {vk}_{i} , {ρ}_{i} , {σ}_{i} \}}_{i ∈ 𝒮} , m )\end{matrix} ] = 1.$$

### Batch Arguments for Monotone Policies

In this section we provide new definitions for batch arguments, specifically BARGs with adaptive subset extraction, and BARGs with functional subset extraction, both for monotone policies. The definitions extend the definition of BARGs for monotone policies considered in prior work. We then show how to construct aggregate signatures from BARGs with adaptive subset extraction, and weakly unforgeable aggregate signatures from BARGs with functional subset extraction.

We defer the construction of these BARGs to later technical sections. Our BARGs are going to be defined for the following batch language considered in prior work.

Definition 5.1. The language Monotone PolicyTMSAT consists of instances of the form x=(f, M, z, T), where:
f: {0, 1}^{k}→{0, 1} is the description of a monotone function.
M is the description of a Turing machine.
z is an input string (to M), and
T is a running time.

An instance x=(f, M, z, T) is in Monotone PolicyTMSAT if it satisfies any one of the following witness relations. The two relations define the same language, but differ in the witness representation. Notably, [symbol] _{sub} allows for witnesses that are sublinear in the batch size k, which will allow us to obtain more efficient provers for our batch arguments.
A R_{full}-witness for x is w=(w₁, . . . , wₖ) such that f(b₁, . . . , bₖ)=1, where bᵢ∈{0, 1} are defined by bᵢ=1 if and only if M(z, i, wᵢ) accepts within T steps.
A R_{sub}-witness for x is w=(i₁, w₁, . . . , iₜ, wₜ) such that:
   1. For every j∈[t], it holds that iⱼ∈[k] and M(z, iⱼ, wⱼ) accepts within T steps.
   2. f(b₁, . . . , bₖ)=1, where bᵢ=1 if and only if i=iⱼ for some j∈[t].

Further, let F={F_{λ} [symbol] be a family of policies, where each f∈F_{λ} is a monotone function f: {0, 1}^{k}→{0, 1}. We say that subset J⊆[k] is necessary for a monotone function f if f [symbol] _{[k]\J})=0.

5.1 Batch Arguments with Adaptive Subset Extraction

The syntax of batch arguments with adaptive subset extraction is similar to the syntax of somewhere-extractable BARGs for monotone policy in prior work, except that the trapdoor generated by the setup algorithm does not depend on a particular subset of indices (or on a single index as in standard somewhere extractable batch arguments. Instead the adaptive subset extraction guarantee will be defined with respect to necessary subsets chosen by the prover as a function of the crs.

Syntax. Let [symbol] be a witness relation for Monotone PolicyTMSAT (either [symbol] _{full} or [symbol] _{sub}). Let α=α(λ) be a polynomial. A F-batch argument with α-adaptive subset extraction for relation [symbol] consists of the following polynomial-time algorithms:
Setup(1^{λ})→(crs, td). This is a probabilistic setup algorithm that takes as input the security parameter 1^{λ}. It outputs a common reference string crs and a trapdoor td.
[symbol] (crs, f, M, z, 1^{T}, w)→π. This is a deterministic prover algorithm that takes as input the common reference string crs, policy f, Turing machine M, input z, runtime 1^{T}, and witness w (for the relation [symbol] ). It outputs a proof π.
[symbol] (crs, x, π)→0/1. This is a deterministic verification algorithm that takes as input the common reference string crs, instance x=(f, M, z, T), and a proof π. It outputs a bit (1 to accept, 0 to reject).
Extract(td, π)→(i, wᵢ). This is a deterministic extraction algorithm that takes as input the trapdoor td, and a proof π. It outputs an index i∈[k], and a witness wᵢ.

Definition 5.2 (Batch Argument for Policies with Adaptive Subset Extraction). A F-batch argument with α-adaptive subset extraction (Setup, [symbol] , [symbol] , Extract) for relation [symbol] is required to satisfy the following properties:
Completeness. For any λ∈ [symbol] , any n, m, T≤2^{λ}, any instance x=(f, M, z, T)∈ Monotone PolicyTMSAT with |M|+|z|=n and corresponding witness w such that (x, w)∈ [symbol] and |wᵢ|=m,

$$Pr [ ( crs , x , π ) = 1 : \begin{matrix}( crs , td ) ← Setup ( {1}^{λ} ) \\ π ← ( crs , f , M , 𝓏 , {1}^{T} , w )\end{matrix} ] = 1 .$$

Succinctness. In the completeness experiment above, |π|≤m·poly(λ). The running time of the verifier is at most poly(|crs|+|π|)+poly(λ)·|x|.
α-Adaptive Subset Extraction. For any polynomial T(λ), any poly-size cheating prover [symbol] , and any sequence {f_{λ}∈F_{λ}}_{λ∈} [symbol] _{, there exists a negligible function negl(·) such that for every λ∈} [symbol] _{,}

$${Pr}_{EXP} [ i ∈ J ∧ M ( 𝓏 , i , {w}_{i} ) = 1 ] \geq \frac{1}{α ( λ )} \cdot {Pr}_{EXP} [ \begin{matrix}( crs , x , π ) = 1 ∧ \\ f ( {[ k ] \backslash J}_{} ) = 0\end{matrix} ] - negl ( λ ) ,$$

where EXP is the experiment defined as follows:
   Generate (crs, td)←Setup(1^{λ}).
   Run the cheating prover and obtain (M, z, π, J)→ [symbol] (crs).
   Let x=(f_{λ}, M, z, T).
   Extract (i, wᵢ)←Extract(td, π).
      5.2 Batch Arguments with Functional Subset Extraction

We now consider a related notion of functional subset extraction, which generalizes the notion of somewhere extractable BARGs for monotone policy defined in prior work. Here, we program the crs on some function g whose outputs are subsets of [k]. The extraction guarantee we will require that if prover and verifier both use a function input y, we can extract from the proof a witness from the set J=g(y), as long as J is a necessary subset. Unlike the definition of adaptive subset extraction considered in Section 5.1, where the crs does not require additional input, we note that here we do have to program a crs but the adversary is allowed to adaptively pick the input y to the function g.

Syntax. Let [symbol] be a witness relation for Monotone PolicyTMSAT (defined in Definition 5.1). The syntax remains largely the same as in the case of BARGs adaptive subset extraction, with the primary difference pertaining to the additional function g specified during setup, and the additional input y used by both parties.

A F-batch argument with functional subset extraction consists of the following polynomial-time algorithms:
Setup(1^{λ}, g)→(crs, td). This is a probabilistic setup algorithm that takes as input the security parameter 1^{λ} and a function g∈G_{λ}. It outputs a common reference string crs and a trapdoor td.
[symbol] (crs, y, f, M, z, 1^{T}, w)→π. This is a deterministic prover algorithm that takes as input the common reference string crs, function input y, policy f, Turing machine M, input z, runtime 1^{T}, and witness w (for the relation [symbol] ). It outputs a proof π.
[symbol] (crs, y, x, π)→0/1. This is a deterministic verification algorithm that takes as input the common reference string crs, function input y, instance x=(f, M, z, T), and a proof π. It outputs a bit (1 to accept, 0 to reject).
Extract(td, y, π)→(i, wᵢ). This is a deterministic extraction algorithm that takes as input the trapdoor td, and a proof π. It outputs an index i∈[k], and a witness wᵢ.

Definition 5.3 (Batch Argument for Policies with Functional Subset Extraction). A F-batch argument with G-functional subset extraction (Setup, [symbol] , [symbol] , Extract) for relation [symbol] is required to satisfy the following properties:
Completeness. For any λ∈ [symbol] , any k, n, m, [symbol] , T≤2^{λ}, any instance x=(f, M, z, T)∈ Monotone PolicyTMSAT with |M|+|z|=π and corresponding witness w such that (x, w)∈ [symbol] and |wᵢ|=m, any function g∈G_{λ}, and any function input y∈{0, 1 [symbol] ,

$$Pr [ ( {crs}_{} , y , x , π ) = 1 : \begin{matrix}( crs , td ) ← Setup ( {1}^{λ} , g ) \\ π ← ( crs , y , f , M , 𝓏 , {1}^{T} , w )\end{matrix} ] = 1 .$$

Succinctness. In the completeness experiment above, |π|≤m·poly(λ) and |crs|≤(m+|g|)·poly(λ) where |g| is the description length of the function g.
Key Indistinguishability. For any poly-size adversary [symbol] , any polynomial T(λ) and any functions g₁, g₁∈G_{λ} there exists a negligible function negl(·) such that for every λ∈

[symbol]

$$Pr [ ( crs ) = b : \begin{matrix}b ← \{ 0 , 1 \} , \\ ( crs , td ) ← Setup ( {1}^{λ} , {g}_{b} )\end{matrix} ] \leq \frac{1}{2} + negl ( λ ) .$$

G-Functional Subset Extraction. For any polynomial T(λ) and any poly-size cheating prover [symbol] , there exists a negligible function negl(·) such that for every λ∈ [symbol] and g∈G_{λ}

$${Pr}_{EXP} [ \begin{matrix}( {crs}_{𝒱} , y , x , π ) = 1 ∧ \\ f ( {[ k ] \backslash J}_{} ) = 0 ∧ \\ ( i ∉ J ∨ M ( 𝓏 , i , {w}_{i} ) = 0 )\end{matrix} ] \leq negl ( λ ) .$$

where EXP is the experiment defined as follows:
   Generate (crs, td)←Setup(1^{λ}, g).
   Run the cheating prover and obtain (M, z, π, y)→ [symbol] (crs).
   Let x=(f_{λ}, M, z, T) and J=g(y).
   Extract (i, wᵢ)←Extract(td, y, π).

Remark 5.1 (Hashed inputs). We additionally support a syntax where the verifier receives a hash of the function input y (for some hash family with local opening), rather than the full input. This allows for an efficient verifier in case the function input is long. Looking ahead, this will be the case in our construction in Section 5.4.

With this syntax, security is modified so that it holds if the verifier receives an honestly computed hash of y. We note that this notion can be obtained generically, using RAM SNARGs (where the BARG proof contains a RAM SNARG proof that the verifier accepts). A similar transformation was implemented in prior work, to obtain a predicate-extractable hash family with efficient verification.

### 5.3 From Adaptive Subset Extraction to Aggregate Signatures

We present our first transformation, where we construct aggregate signatures from BARGs with adaptive subset extraction, and any signature scheme. Specifically, let F={F_{λ}} be a family of monotone policies. We construct an F-aggregation scheme for S (Definition 4.1) from the following building blocks:
A digital signature scheme S=(KeyGen, Sign, Verify).
An F-batch argument with α-adaptive subset extraction (Definition 5.2)
   (Setup_{BARG}, [symbol] _{BARG}, [symbol] _{BARG}, Extract_{BARG}) for relation [symbol] , where α is some polynomial. For simplicity we assume [symbol] = [symbol] _{full}. We note that a similar construction with [symbol] = [symbol] _{sub} gives a F-aggregation scheme with sublinear aggregation (Section 4.1).
A hash family with local opening (Definition 3.2)
   (Gen_{HT}, Hash_{HT}, Open_{HT}, Verify_{HT}).

We describe the aggregate signature algorithms herein.

Theorem 5.4. Assuming the existence of a digital signature scheme, hash family and F-batch argument with α-adaptive subset extraction, the construction given herein is an F-aggregation scheme for S.

### 5.4 From Functional Subset Extraction to Weakly Unforgeable Aggregate Signatures

We present our second transformation, where we construct weakly unforgeable aggregate signatures from BARGs with functional subset extraction. Our construction will require signature schemes with an additional property that we call signature scheme with trapdoor keys. We start by describing this notion, before we move to the construction of the aggregate signature scheme.

5.4.1 Signature with Trapdoor Keys

We extend the definition of digital signatures S=(KeyGen, Sign, Verify) with an additional property of trapdoor verification keys. This is a requirement on the key generation algorithm of a signature scheme that when provided with a randomly sampled trapdoor td←{0, 1}^{λ}, we can generate “trapdoor keys”. Such trapdoor keys are indistinguishable from honest keys, but their verification keys vk can be recognized using the corresponding trapdoor. Additionally, without the trapdoor, it is hard to forge new “false positive” verification keys vk that are recognized as trapdoor keys, even if given a polynomial number of trapdoor key samples.

Definition 5.5 (Signature with Trapdoor Keys). A digital signature scheme S=(KeyGen, Sign, Verify) has trapdoor keys if it additionally supports the following syntax:
KeyGen(1^{λ}, td)→(sk, vk). This is a PPT algorithm that takes as input the security parameter 1^{λ} and a trapdoor td∈{0, 1}^{λ}. It outputs a signing key sk and a verification key vk.
Extract(td, vk)→{0, 1}. This is a deterministic polynomial-time algorithm that takes as input a trapdoor td∈{0, 1}^{λ} and a verification key vk. It outputs a bit (0 if it is a normal key, 1 if it is a trapdoor key).

We additionally require the following properties:

Key Indistinguishability. For any poly-size adversary [symbol] , and for any polynomial n(λ), there exists a negligible function negl(·) such that for every λ∈ [symbol] ,

$$Pr [ ( {\{ {sk}_{i}^{b} , {vk}_{i}^{b} \}}_{i ∈ [ n ]} ) = b : \begin{matrix}td ← {\{ 0 , 1 \}}^{λ} \\ ∀ i ∈ [ n ] , ( {sk}_{i}^{0} , {vk}_{i}^{0} ) ← KeyGen ( {1}^{λ} , td ) \\ ∀ i ∈ [ n ] , ( {sk}_{i}^{1} {vk}_{i}^{1} ) ← KeyGen ( {1}^{λ} ) \\ b ← \{ 0 , 1 \}\end{matrix} ] \leq \frac{1}{2} + negl ( λ ) .$$

We remark that this property implies that correctness and unforgeability holds for keys sampled by KeyGen(1^{λ}, td) for a random td←{0, 1}^{λ}.

Extraction Correctness. For any λ∈

[symbol]

$$Pr [ Extract ( td , vk ) = 1 : \begin{matrix}td ← {\{ 0 , 1 \}}^{λ} \\ ( sk , vk ) ← KeyGen ( {1}^{λ} , td )\end{matrix} ] = 1 .$$

Additionally, for any poly-size adversary [symbol] , and for any polynomial n(λ), there exists a negligible function negl(·) such that for every λ∈ [symbol] ,

$$Pr [ \begin{matrix}Extract ( td , vk ) = 1 ∧ \\ vk ∉ {\{ {vk}_{i} \}}_{i ∈ [ n ]}\end{matrix} : \begin{matrix}td ← {\{ 0 , 1 \}}^{λ} \\ ∀ i ∈ [ n ] , ( {sk}_{i} , {vk}_{i} ) ← KeyGen ( {1}^{λ} , td ) \\ vk ← ( {1}^{λ} , {\{ {sk}_{i}^{b} , {vk}_{i}^{b} \}}_{i ∈ [ n ]} )\end{matrix} ] \leq negl ( λ ) .$$

We note that given a signature scheme S=(KeyGen, Sign, Verify), we can construct a signature scheme S′ with trapdoor keys, by appending a random padding pad←{0, 1}^{λ} to its verification keys. To generate a trapdoor key (sk′, vk′)←KeyGen′(1^{λ}, td), we instead append a pseudorandom padding pad=PRF(td, vk). Extraction is implemented by comparing pad to PRF(td, vk), and the required properties follow from PRF security. We state the following lemma without proof for the above stated construction, and note that the proof follows in a straightforward manner akin to the construction of message authentication codes (MAC) from PRF: (i) extraction correctness follows from the guarantee that the PRF behaves like a MAC on the verification key; and (ii) key indistinguishability follows from the pseudorandomness of the PRF.

Lemma 5.6. Assuming the existence of a PRF and a signature scheme, there exists a signature scheme with trapdoor keys.

### 5.4.2 Construction

We now describe our construction that uses BARGs with functional subset extraction and a signature scheme with trapdoor keys. Specifically, let F={F_{λ}} be a family of monotone policies. We construct an F-aggregation scheme with weak unforgeability for S (Definition 4.2) from the following building blocks:
A signature scheme with trapdoor keys S=(KeyGen, Sign, Verify) (Definition Definition 5.5).
A F-batch argument with G-functional subset extraction for relation [symbol] _{full} with hashed inputs (Definition 5.3 and Remark 5.1)
   Setup_{BARG}, [symbol] _{BARG}, [symbol] _{BARG}, Extract_{BARG}),
where G={G_{λ}}_{λ∈} [symbol] is a family of polynomial size circuits, with a polynomial bound set to support computing the Extract algorithm of the underlying signature scheme with trapdoor keys.
A hash family with local opening (Definition 3.2)
   (Gen_{HT}, Hash_{HT}, Open_{HT}, Verify_{HT}).

We describe the aggregate signature algorithms. The construction is identical to Section 5.3, except that the BARG algorithms now receive a function and tag as needed, where we program the null function (later modified in the security proof), and our tag is the tuple of verification keys (vk₁, . . . , vkₖ) (or the hashed aggregate verification keys [symbol] for the verifier, following the syntax in Remark 5.1).

Theorem 5.7. Assuming the existence of a digital signature scheme with trapdoor keys, hash family and F-batch argument with G-functional subset extraction, the construction given herein is an F-aggregation scheme for S.

### 6 Composable Verifiable Private Information Retrieval for Policies

In this section, we introduce and construct the main building block in the construction of our BARGs with adaptive subset extraction for read-once monotone policies, composable verifiable private information retrieval (vPIR). Our notion of composable vPIR extends the notion of vPIR to handle a composable definition of security, and additionally monotone policies, both of which is necessary to construct our BARGs with adaptive subset extraction for read-once monotone policies in Section 7.

We start by defining of composable vPIR for policies in Section 6.1. In Section 6.2 we give a construction of vPIR that supports our extensions, and in Section 6.3 we extend the analysis of prior work to show that this construction satisfies our new composable security definition. We first briefly describe vPIR for policies, and how it differs from the notion considered in prior work.

vPIR for policies. The prior work considers vPIR for bounded space global database constraints. Such constraints are evaluated by reading the rows of the database one by one and maintaining a state of bounded size between rows. In the adaptive setting, where the adversary may choose the constraint as a function of the vPIR query, the security of their construction degrades exponentially with the description length of the constraint (given by a program that updates state). However, in the non-adaptive setting, their construction does not incur such loss.

We consider a particular type of bounded space global constraints that are suitable for describing policies. The description of such constraints can be separated into two parts: a program Γ and a vector of instances X, one for every row in the database. The program updates the state as a function of both the current row and the corresponding instance. Looking ahead, in our application the instances may be chosen adaptively. Therefore, relying on the construction from prior work would result in exponential security loss. However, in our instantiation the security loss is only exponential in the description length of the program Γ and not of the instances. Moreover, in the adaptive setting, the simulator in the definition from prior work is required to produce the entire constraint (Γ, X) (this constraint together with the simulated client's output row D[t] is required to be indistinguishable from the constraint and output in the real world), while our notion is relaxed: we only simulate the constraint Γ and the relevant instance X[t].

### 6.1 Definition

We define a simulation security notion for multiple parallel executions of vPIR. While one could consider general forms of composition, we focus on the setting where a single client is sending a single vPIR query to p (potentially colluding) servers, each holding a different database and constraint. In this setting, we require the simulator to produce the output of the client (including the database row and constraint) in all p interactions.

For simplicity, in Definition 6.1 we simplify this further and only consider the case of p=2 colluding servers, which suffices for our applications to BARGs with adaptive subset extraction and aggregate signatures. However we note that the definition can be naturally extended to define p-composable vPIR.

Read-once bounded-space policy constraints. For parameters T, S, we define a read-once bounded-space constraint represented as a Turing machine Γ∈{0, 1}^{N} and instances X=(xᵢ)_{i∈[k]}∈{0, 1}^{k×n}. We say that a database D=(rᵢ)_{i∈[k]}∈{0, 1}^{k×w} satisfies the policy defined by (Γ, X) if and only if for every i∈[k−1] there exists cᵢ∈{0, 1}^{S} such that Γ(cᵢ₋₁, xᵢ, rᵢ) outputs cᵢ within T steps where c₀, cₖ are some fixed starting and accepting configurations. We denote by U_{T,S}(Γ, X, D) the bit that indicates whether or not D satisfies the policy (Γ, X).

Syntax. A verifiable private information retrieval (vPIR) scheme for policies consists of the following polynomial-time algorithms:
Query(1^{λ}, t)→(dk, vk, q). This is a probabilistic algorithm that takes as input the security parameter 1^{λ}, and a row index t∈[2^{λ}]. It outputs a decryption key dk, a verification key vk and a query q.
Answer(D, 1^{T}, Γ, X, q)→a. This is a deterministic algorithm that takes as input a database D∈{0, 1}^{k×ω}, a time-bound 1^{T}, a constraint Γ, instances X∈{0, 1}^{k×n}, and a query q. It outputs an answer a.
Dec(dk, a)→r. This is a deterministic algorithm that takes as input a decryption key dk, and an answer a. It outputs a row Γ∈{0, 1}).
Verify(vk, Γ, X, a)→0/1. This is a deterministic algorithm that takes as input a verification key vk, a constraint Γ, instances X∈{0, 1}^{k×n}, and an answer a. It outputs a bit (1 to accept, 0 to reject).

Remark 6.1 (Index instances). In our constructions in Section 7, we only need to consider instances X of the form X=(x, i)_{i∈[k]} for some x∈{0, 1}ⁿ that is the same in all rows. We note that in this case, the Answer, Verify algorithms may receive just x rather than X=(x, i)_{i∈[k]} (and so the verification time is independent of k).

Definition 6.1. A Λ-secure 2-composable vPIR scheme for policies (Query, Answer, Dec, Verify) is required to satisfy the following properties:
Completeness. For any λ∈ [symbol] , any T, N, S, k, n, ω≤2^{λ}, database D∈{0, 1}^{k×ω}, row index t∈[k], constraint Γ∈{0, 1}^{N} and instances X∈{0, 1}^{k×n} such that U_{T,S}(Γ, X, D)=1,

$$Pr [ \begin{matrix}Dec ( dk , a ) = D [ t ] ∧ \\ Verify ( vk , Γ , X , a ) = 1\end{matrix} : \begin{matrix}( dk , vk , q ) ← Query ( {1}^{λ} , t ) \\ a ← Answer ( D , {1}^{T} , Γ , X , q )\end{matrix} ] = 1.$$

Efficiency. In the completeness experiment above, |vk|+|q|+|a|≤ω·poly(λ).
Λ-Privacy. For any poly(Λ)-size adversary [symbol] there exists a negligible function negl such that for any λ∈ [symbol] and row indices t₀, t₁∈[2^{λ}],

$$Pr [ ( vk , q ) = b : \begin{matrix}b ← \{ 0 , 1 \} \\ ( dk , vk , q ) ← Query ( {1}^{λ} , {t}_{b} )\end{matrix} ] \leq \frac{1}{2} + negl ( Λ ) .$$

2-Composable Λ-simulation security. For any functions T(λ), N(λ), n(λ), k(λ), ω(λ)≤Λ(λ), function S(λ)=O(log Λ), any poly(Λ)-size adversary [symbol] and polynomial P there exists a poly(Λ)-size simulator Sim such that for any poly(Λ)-size distinguisher [symbol] , λ∈ [symbol] , constraints Γ, Γ′∈{0, 1}^{N}, and row index t∈[k],

$$\vert Pr [ ( {Real}_{} ( λ , Γ , {Γ}^{′} , t ) ) = 1 ] - Pr [ ( {Ideal}_{Sim} ( λ , Γ , {Γ}^{′} , t ) ) = 1 ] \vert < \frac{1}{P ( Λ )} ,$$

where the experiments Real [symbol] (λ, Γ, Γ′, t) and Ideal_{Sim}(λ, Γ, Γ′, t) are defined as follows:
Real [symbol] (λ, Γ, Γ′, t):
   Generate a query (dk, vk, q)←Query(1^{λ}, t).
   Run the adversary and obtain (X, X′, a, a′)← [symbol] (vk, q).
   If Verify(vk, Γ, X, a)=1 and Verify(vk, Γ′, X′, a, a′)=1 output(X[t], X′[t], Dec(dk, a), Dec(dk, α′)).
   Otherwise output ⊥.
Ideal_{Sim}(λ, Γ, Γ′, t):
   Run the simulator and obtain (X, X′, D, D′)←Sim(λ, Γ, Γ′).
   If U_{T,S}(Γ, X, D)=1 and U_{T,S}(Γ′, X′, D′)=1 output(X[t], X′[t], D[t], D′[t]).
   Otherwise output ⊥.

### 6.2 Construction

In this section we construct a 2-composable vPIR for policies. The construction is similar to the construction given in prior work, slightly modified to handle our extensions. It uses the following building blocks:
A Λ-secure hash family with local opening (Definition 3.2)
   (Gen_{HT}, Hash_{HT}, Open_{HT}, Verify_{HT}).
A Λ-secure seBARG scheme (Definition 3.5)
   (Gen_{seBARG}, [symbol] _{seBARG}, [symbol] _{seBARG}, Extract_{seBARG}).

We are now ready to describe our 2-composable vPIR scheme for policies.

### 6.3 Analysis

In this section we analyze the construction given in Section 6.2, and prove the following theorem:

Theorem 6.2. Assuming a Λ-secure hash family with local opening and a Λ-secure somewhere-extractable batch argument scheme, there exists a Λ-secure 2-composable vPIR scheme for policies.

Our analysis, detailed below, is similar to the analysis of simulation secure vPIR in prior work, with some parts taken verbatim from the full version. We extend it to handle policy constraints, and 2-composable simulation security.

Before proceeding with the formal proof, we describe the high-level ideas in our analysis. We first recall the simulator given in prior work. It simulates an accepting database using coupling: for each row index in the database i∈[k], it repeatedly queries the server for this index and constructs a list Lᵢ of tuples (cᵢ₋₁, rᵢ), where cᵢ₋₁ is the intermediate configuration of the bounded-space constraint Γ before reading the corresponding row rᵢ. Then, it couples the lists L₁, . . . , Lₖ to create a list L of full databases, so that the intermediate configurations “connect” to a consistent execution of Γ. Finally it samples a random database from this list.

We now describe the changes in our analysis. To support policies (where we also need to simulate instances X∈{0, 1}^{k×n}), our simulator constructs the list Lᵢ so that it contains tuples (cᵢ₋₁, xᵢ, rᵢ) (where xᵢ is the ith instance given by the prover in this query), then couples the lists in the same way. To extend the analysis to composition of p parallel executions, each element in the list Lᵢ is a p-tuple of (cᵢ₋₁^{j}, xᵢ^{j}, rᵢ^{j})_{j∈[p]}, with one configuration-instance-row tuple corresponding to each server. We then couple L₁, . . . , Lₖ to obtain a list L such that each individual database connects.

We note that, in order for the coupling argument to work, we need to assume hardness assumptions that are exponential in the support size of the function according to which we're coupling (which, in our case, is the combined size of all intermediate configurations cfᵢ in the p parallel executions, for any given i). In prior work this is what limits the space S of the constraint to O(log Λ), and in our case the limit is p·S=O(log Λ), assuming Λ-hardness of the underlying building blocks.

Remark 6.2. Finally, we note that the above construction and analysis extend to any p-composable vPIR for p=O(1) (or, more generally, to p·S=O(log Λ) assuming Λ-security of the underlying building blocks, where S is the space bound of the constraint Γ).

7 BARGs with Adaptive Subset Extraction for Bounded-Space Policies

In this section, we use our constructed 2-composable vPIR for policies (Definition 6.1) to construct batch arguments with adaptive subset extraction.

We proceed by defining the families of policies we support and stating our main theorems.

Definition 7.1 (Read-Once Space-S Policies). Let S(λ) be a function and let F={F_{λ} [symbol] be a family of functions. F is a read-once space-S family of policies if there exist polynomials T(λ), N(λ), k(λ) such that each f∈F_{λ} is a monotone function f: {0, 1}^{k}→{0, 1}, and there exists a Turing machine Γ∈{0, 1}^{N} such that f(b₁, . . . , bₖ)=1 if and only if for every i∈[k−1] there exists cᵢ∈{0, 1}^{S} such that Γ(cᵢ₋₁, bᵢ) outputs cᵢ within T steps where c₀, cₖ are some fixed starting and accepting configurations.

Theorem 7.2 (Section 7.1). Let Λ=Λ(λ) be a function. Assuming a Λ-secure 2-composable vPIR scheme for policies, there exists a scheme BARG=(Setup, [symbol] , [symbol] , Extract) such that for any family F of read-once space S policies where S=O(log Λ), BARG is a F-batch argument with O(k)-adaptive subset extraction for relation [symbol] _{full}.

Using Theorem 5.4 and Theorem 7.2 above, we obtain the following theorem on aggregate signatures.

Theorem 7.3. Let Λ=Λ(λ) be a function. Assuming a Λ-secure 2-composable vPIR scheme for policies and a Λ-secure hash family with local opening, there exists a schemeAggS=(Setup, KeyAgg, SigAgg, AggVerify) such that for any family F of read-once space S policies where S=O(log Λ) and for any digital signature scheme S, AggS is a F-aggregation scheme for S.

We define below a specific family of monotone function, that of threshold policies.

Definition 7.4 (Weighted Threshold Policies). Let F={F_{λ} [symbol] be a family of functions. F is a family of weighted threshold policies if there exist polynomials k(λ), {aᵢ(λ)}_{i∈[k]}, t(λ) such that each f∈F_{λ} is a function f: {0, 1}^{k}→{0, 1} such that f(b₁, . . . , bₖ)=1 if and only if bᵢ∈{0, 1} and Σᵢ₌₁₌₁^{k}aᵢbᵢ≥t.

Theorem 7.5 (Section 7.2). Assuming a (polynomially-secure) 2-composable vPIR scheme for policies, there exists a scheme BARG=(Setup, [symbol] , [symbol] , Extract) such that for any family F of weighted threshold policies with threshold t, BARG is a F-batch argument with O(t)-adaptive subset extraction for relation [symbol] _{sub} (where the aggregation time is polynomial in t).

Thus, again using Theorem 5.4 and the Theorem 7.5 we have the following theorem.

Theorem 7.6. Assuming a 2-composable vPIR scheme for policies and a hash family with local opening, there exists a scheme AggS=(Setup, KeyAgg, SigAgg, AggVerify) such that for any family F of weighted threshold policies with threshold t and for any digital signature scheme S, AggS is a F-aggregation scheme for S with aggregation time polynomial in t.

Note that by setting αᵢ=1, in the above theorems, we revert to the (unweighted) threshold setting, where the aggregation time now depends on the number of signatures t.

### 7.1 Adaptive Subset Extraction for Bounded-Space Policies

### 7.1.1 Construction.

Our construction uses as a building block a Λ-secure 2-composable vPIR scheme for policies
(Query, Answer, Dec, Verify),
   where we use the syntax for index instances (as in Remark 6.1).
   7.2 Adaptive Subset Extraction with Sublinear Prover for Threshold Policies

In this section, we use 2-composable vPIR to construct batch arguments with adaptive subset extraction for the sublinear relation [symbol] _{sub}.

On sublinear provers for general monotone policies. We begin by describing a general approach towards achieving a sublinear prover for any read-once bounded-space policy. The idea is to consider a compressed vPIR database, corresponding to the [symbol] _{sub}-witness: suppose the witness is (i₁, w₁, . . . , iₜ, wₜ), where i₁, . . . , iₜ are sorted in increasing order. We consider the vPIR database that contains t rows, each containing an index-witness pair. Then, the BARG verifier would verify that this database satisfies the constraint corresponding to the validity of this witness: (i) the indices are sorted, (ii) all witnesses are valid, and (iii) the input b₁, . . . , bₖ where bᵢ=1⇔∃j.i=iⱼ satisfies the policy f.

First, we observe that for general bounded-space policies, it is not clear that the prover can evaluate this constraint on the database in sublinear time (i.e. in time that only depends on the compressed database size and not on k). Indeed, the difficulty lies in (iii) above: to update the function's state between rows j and j+1, the prover needs to compute iⱼ₊ᵢ−iⱼ steps of the function, which could take up to linear time. We propose two ways to handle this issue:
First, we can restrict the class of policies f to ones with a “fast-forward” property, where one can update f's state reading any number of repeated zeroes in time that depends sublinearly in this number. For example, weighted threshold policies satisfy this property (in fact, zeroes do not change their state at all).
Alternatively, we can also support general monotone policies, at the expense of having a long crs, which the prover has random access to. This crs could contain a table of states of f after any number of zeroes, which the prover can later use instead of performing the computation during proof generation (we note that in order to convince the verifier, the long crs should also contain SNARG proofs that each table entry is correct).

We next discuss security of our candidate construction, and whether we can obtain it from our 2-composable vPIR notion.

We start by looking at the case of threshold policies. Similarly to our construction in Section 7.1, given a cheating prover that outputs a vPIR answer a and a necessary subset J, we consider a composed prover that gives an additional vPIR answer based on the database corresponding to this subset J, and the constraint that checks that it is necessary, i.e. that |J|>k−t. To use composition, we encode J as a database D′ of size t (matching the size of the prover's database), consisting of rows (ĩⱼ₋₁, ĩⱼ) where ĩⱼ are such that the edges are ĩ₀=0 and ĩₜ=k+1, and the points cover J̅, i.e. J̅⊆{ĩ₁, . . . , ĩₜ₋₁}.

Given this cheating prover, our composition theorem guarantees a simulator for the joint distribution of the databases D=(iⱼ, wⱼ)_{j∈[t]} and D′=(ĩⱼ₋₁, ĩⱼ)_{j∈[t]}. Now, we use the combinatorial property that every pair of valid databases D, D′ must contain a row j such that iⱼ is contained in the open interval (ĩⱼ₋₁, ĩⱼ), which implies that iⱼ∈J. This gives us the adaptive subset extraction property: sampling a random row in the database, with probability 1/k we're guaranteed to find a row j such that wⱼ is valid and iⱼ∈J.

This analysis also extends to weighted threshold policies, by expanding the database to contain multiple copies of each witness, corresponding to the weight. Unfortunately, it seems that the same approach doesn't extend to general bounded-space policies. Instead, we can argue security using a direct analysis, utilizing additional properties of the vPIR construction in Section 6 that do not seem to be captured by our composition theorem.

In a nutshell, the issue is with defining the encoding of J as a database. For the case of thresholds, we exploited the fact that the complement of a necessary subset must be smaller in size than any satisfying subset to the policy, to encode J as a sequence of t open intervals in J. For general policies, where this fact does not hold, it's not clear how to encode J. We could try to compress J̅ to t rows by encoding multiple such intervals in each row, but for any fixed choice of the number of intervals in each row, we could find a set of valid databases where our combinatorial property doesn't hold, i.e. there is no row j such that the index iⱼ is contained in some open interval in the same row.

To solve this problem, we can open up the proof of our composition theorem, and define a “dynamic” database structure for J that depends on the rows (iⱼ, wⱼ) in D to choose precisely how many elements of J̅ to include in each row. In more detail, using the same simulation strategy as in Section 6 we can repeatedly query [symbol] on each index j, by running [symbol] (q)→(a, J) for (dk, vk, q)←Query(1^{λ}, j) and decrypting the database row (iⱼ₋₁, iⱼ, wⱼ)=rⱼ=Dec(dk, a) (we include the previous index iⱼ₋₁ as part of each database row). Then, we construct a list Lⱼ of answers of the form (iⱼ₋₁, iⱼ, wⱼ, J̅∩(iⱼ₋₁, iⱼ]). Finally, using the coupling lemma, we can couple together the lists L₁, . . . , Lₜ according to (iⱼ₋₁, iⱼ, wⱼ)_{j∈[t]} being an accepting database (i.e., iⱼ that appears in the jth and j+1-th rows should be equal, and wⱼ should all be valid witnesses), and the set J̅ composed of the intervals J̅∩(iⱼ₋₁, iⱼ] not satisfying the policy, i.e. J being a necessary subset (note these two conditions can be checked with a bounded size state between rows).

We then have that in any such pair of databases, since the set of witnesses satisfy the policy and J is a necessary subset, there must exist an index j∈J such that wⱼ is an accepting witness for the iⱼth statement, and iⱼ∈J. But now, since we defined J's database structure such that its rows J∩(iⱼ₋₁, iⱼ] exactly match the indices of valid witnesses, we have that just row j in the simulated pair of databases is enough to decide if J contains the index iⱼ. Thus this property is maintained in the real world experiment, and we get O(t)-adaptive subset extraction by extracting at a random row index j.

### 7.2.1 Construction.

Our construction uses as a building block a composable polynomially-secure vPIR scheme for policies
(Query, Answer, Dec, Verify),
   where we use the syntax for index instances (as in Remark 6.1).
   8 BARGs with Functional Subset Extraction for Monotone Circuit Policies

In this section, we construct functional subset extraction for monotone functions that can be represented as polynomial size circuits. We state the following theorem, and provide a proof sketch since analysis follows identically to the analysis presented in prior work.

Theorem 8.1. Assuming a somewhere-extractable batch argument scheme (Definition 3.5) and fully homomorphic encryption, there exists a scheme BARG=(Setup, [symbol] , [symbol] , Extract) such that for any family F of monotone circuit policies and family G of functions computable by polynomial-size circuits, BARG is a F-batch argument with G-functional subset extraction for relation [symbol] _{full} with hashed inputs.

Combining Theorem 5.7 and Theorem 8.1 above, we have the following theorem about weakly unforgeable aggregate signatures.

Theorem 8.2. Assuming a somewhere-extractable batch argument scheme (Definition 3.5) and fully homomorphic encryption, there exists a scheme AggS=(Setup, KeyAgg, SigAgg, AggVerify) such that for any family F of functions computable by polynomial-size monotone circuits and for any digital signature scheme S with trapdoor keys, AggS is a F-aggregation scheme for S.

### 8.1 Construction and Proof Sketch

In this section we give a proof sketch for Theorem 8.1. We recall the construction of batch arguments for monotone circuit policies from prior work, and show that it can support functional subset extraction (defined in Section 5.2).

In Section 8.1.1, we recall the notion of a predicate-extractable hash, and extend the definition to support functional predicate extraction. This extension was in fact already used in prior work, to get a shorter common reference string for their SNARG.

Then, in Section 8.1.2 we recall the construction of a somewhere-extractable SNARG for monotone policy BatchNP from prior work. We show that instantiating this construction with a functional predicate-extractable hash, we get a batch argument with functional subset extraction.

### 8.1.1 Predicate Extractable Hash (PEHash)

In this section we define predicate-extractable hash with tags for bit-fixing predicates. The definition is taken from prior work. This is a notion that generalizes the notion of a somewhere-extractable hash. Whereas a somewhere-extractable hash allows to generate a hash key hk, programmed on an index i and use a corresponding trapdoor tdᵢ to extract xᵢ from rt=Hash(hkᵢ, x), a predicate-extractable hash for a family [symbol] allows to generate a hash key programmed on a global predicate f∈ [symbol] , and extract the value of f(x). Prior work constructs such hash families for the bit-fixing family of predicates, where each f∈ [symbol] is defined by a set J⊆[k] and a string s∈{0, 1}^{J}, and we have f(x)=1iff∀j∈J, xⱼ=sⱼ.

We consider an extended definition that supports functional predicate extraction. This allows to program the PEHash on a function g during key generation (rather than on a predicate specified by J, s), then specify an input y to the function when hashing a string x. This produces a hash value, from which we can extract the value of the predicate f=g(y) on x.

Syntax. Let G={G_{λ} [symbol] be a collection of functions such that every g∈G_{λ} maps inputs to bit-fixing predicates f. For g∈G_{λ}, we denote its description length as a circuit by |g|.

A G-functional predicate extractable hash family PEHash with tags with respect to the bit-fixing predicate family consists of the following polynomial-time algorithms:
Gen(1^{λ}, g)→(hk, vk, td). This is a probabilistic setup algorithm that takes as input a security parameter 1^{λ} in unary, and a function g∈G_{λ}. It outputs a hash key hk, verification key vk and trapdoor td.
Hash(hk, y, x, \vec{t})→v. This is a deterministic algorithm that takes as input a hash key hk, a function input y, a hash input x∈{0, 1}^{N}, and tags \vec{t}=(t₁, . . . , t_{N})∈({0, 1}^{T})^{N}. It outputs a hash value v∈{0, 1}^{T·poly(λ)}.
Open(hk, y, x, \vec{t}, j)→ρ. This is a deterministic algorithm that takes as input a hash key hk, a function input y, a hash input x∈{0, 1}^{N}, tags \vec{t}=(t₁, . . . , t_{N})∈({0, 1}^{T})^{N} and an index j∈[N]. It outputs an opening ρ∈{0, 1}^{T·poly(λ)}.
Verify(vk, y, v, j, b, t, p)→0/1. This is a deterministic algorithm that takes as input a verification key vkᵢ a function input y, a hash value v∈{0, 1}^{T·poly(λ)}, an index j∈[N], a bit b∈{0, 1}, a tag t∈{0, 1}^{T} and an opening ρ∈{0, 1}^{T·poly(λ)}, and outputs 1 (accept) or 0 (reject).
Extract(td, y, v)→u. This is a deterministic extraction algorithm that takes as input a trapdoor td, a function input y and a hash value v∈{0, 1}^{T·poly(λ)}, and outputs a bit u∈{0, 1}.
ExtractIndex(td, y, v)→j. This is a deterministic extraction algorithm that takes as input a trapdoor td, a function input y and a hash value v∈{0, 1}^{T·poly(λ)}, and outputs an index j∈[N].
ExtractTag(td, y, v)→t. This is a deterministic extraction algorithm that takes as input a trapdoor td, a function input y and a hash value v∈{0, 1}^{T·poly(λ)}, and outputs a tag t∈{0, 1}^{T}.

A PEHash is required to satisfy the following basic properties, and additional consistency properties.

Definition 8.3 (PEHash Basic Properties). A G-functional predicate extractable hash family PEHash satisfies the following properties:
Completeness. For any λ∈ [symbol] , any N, T, [symbol] ≤2^{λ}, any function g∈G_{λ}, any function input y∈{0, 1 [symbol] , any index j∈[N], and any x∈{0, 1}^{N} and tags \vec{t}=(t₁, . . . , t_{N})∈({0, 1}^{T})^{N} let f=g(y), then

$$Pr [ \begin{matrix}Extract ( td , v ) = f ( x ) ∧ \\ Verify ( vk , y , v , j , {x}_{j} , {t}_{j} , ρ ) = 1\end{matrix} : \begin{matrix}( hk , vk , td ) ← Gen ( {1}^{λ} , g ) , \\ v = Hash ( hk , y , x , \vec{t} ) , \\ ρ = Open ( hk , y , x , \vec{t} , j )\end{matrix} ] = 1.$$

Succinctness. In the completeness experiment above, the size of the verification key vk and the hash value v is poly(λ). The size of the hash key hk is at most |g|·poly(λ).
Computational binding. For any poly-size adversary [symbol] and polynomial [symbol] (λ) there exists a negligible function negl(·) such that for any λ∈ [symbol] , any function g∈G_{λ} and any function input y∈{0, 1 [symbol] ,

$$Pr [ \begin{matrix}Verify ( vk , y , v , j , 0 , {t}_{0} , {ρ}_{0} ) = 1 ∧ \\ Verify ( vk , y , v , j , 1 , {t}_{1} , {ρ}_{1} ) = 1\end{matrix} : \begin{matrix}( hk , vk , td ) ← Gen ( {1}^{λ} , g ) , \\ ( v , j , {t}_{0} , {t}_{1} , {ρ}_{0} , {ρ}_{1} ) ← ( hk , vk )\end{matrix} ] \leq negl ( λ ) .$$

Function hiding. For any poly-size adversary [symbol] there exists a negligible function negl(·) such that for every λ∈ [symbol] and g₀, g₁∈G_{λ} such that |g₀|=|g₁|,

$$Pr [ ( hk , vk ) = b : \begin{matrix}b ← \{ 0 , 1 \} \\ ( nk , vk , td ) ← Gen ( {1}^{λ} , g )\end{matrix} ] \leq \frac{1}{2} + negl ( λ ) ,$$

Definition 8.4 (PEHash Consistency Properties). The hash family is furthermore required to satisfy the following consistency properties:
Index extraction correctness. For any λ∈ [symbol] , any [symbol] ≤2^{λ}, any function g∈G_{λ} and function input y∈{0, 1 [symbol] such that for f=g(y)=(J, s) we have J≠0, and any hash value v,

$$Pr [ ExtractIndex ( td , y , v ) ∈ J : ( hk , vk , td ) ← Gen ( {1}^{λ} , g ) ] = 1 .$$

Consistency of extraction. For any poly-size adversary [symbol] holds that for any g∈G_{λ}, there exists a negligible function negl(·) such that for any λ∈ [symbol] ,

$$Pr [ \begin{matrix}Extract ( td , y , v ) = 1 ∧ j ∈ J ∧ \\ Verify ( vk , y , v , j , 1 , - {s}_{j} , t , ρ ) = 1\end{matrix} : \begin{matrix}( hk , vk , td ) ← Gen ( {1}^{λ} , g ) , \\ ( y , v , j , t , ρ ) ← ( hk , vk ) , \\ ( J , s ) = g ( y )\end{matrix} ] \leq negl ( λ ) ,$$

$$and$$

$$Pr [ \begin{matrix}Extract ( td , y , v ) = 0 ∧ \\ ExtractIndex ( td , y , v ) = j ∧ \\ Verify ( vk , y , v , j , {s}_{j} , t , ρ ) = 1\end{matrix} : \begin{matrix}( hk , vk , td ) ← Gen ( {1}^{λ} , g ) , \\ ( y , v , j , t , ρ ) ← ( hk , vk ) , \\ ( J , s ) = g ( y )\end{matrix} ] \leq negl ( λ ) .$$

Consistency of tag extraction. For any poly-size adversary [symbol] it holds that for any g∈G_{λ}, there exists a negligible function negl(·) such that for any λ∈ [symbol] ,

$$Pr [ \begin{matrix}Extract ( td , y , v ) = 0 ∧ \\ ExtractIndex ( td , y , v ) = j ∧ \\ ExtractTag ( td , y , v ) \neq t ∧ \\ Verify ( vk , y , v , j , - {s}_{j} , t , ρ ) = 1\end{matrix} : \begin{matrix}( hk , vk , td ) ← Gen ( {1}^{λ} , g ) \\ ( y , v , j , t , ρ ) ← ( hk , vk )\end{matrix} ]$$

Theorem 8.5. Assuming fully homomorphic encryption, there exists a PEHash family with tags with respect to the bit-fixing predicate family, which is G-functional with respect to any family G of polynomial-size circuits.

8.1.2 Functional Subset Extraction from Functional PEHash

We now recall the construction of SNARGs for monotone policy BatchNP from prior work, and replace the PEHash with a functional PEHash to obtain a F-batch argument with G-functional subset extraction, for any family F of monotone circuit policies and G of polynomial size circuits. The construction uses the following building blocks:
A G′-functional PEHash family with tags (Definition 8.4)
   (Gen_{PEHT}, Hash_{PEHT}, Open_{PEHT}, Verify_{PEHT}, Extract_{PEHT}, ExtractIndex_{PEHT}, ExtractTag_{PEHT}) with respect to the bit-fixing predicate family, where G′ is a family of polynomial size circuits, containing a function g′ for every g∈G_{λ}, defined as follows:
   1. Receive an input y∈{0, 1 [symbol] an compute g(y)=J⊆[k].
   2. Output f=(J, s) where s=0^{J} is the all-zero string.
A G″-functional PEHash family
   (Gen_{PEH}, Hash_{PEH}, Open_{PEH}, Verify_{PEH}, Extract_{PEH}, ExtractIndex_{PEH})
   with respect to the bit-fixing predicate family, where G″ is a family of polynomial size circuits, containing a function g″ᵢ for every g∈G_{λ} and i∈[d], defined as follows:
      1. Receive an input y′=(C, y) where C∈F_{λ} is a monotone circuit, and y∈{0, 1 [symbol] is an input to g. [symbol]
      2. Compute g(y)=J⊆[k].
      3. Let (b*₁, . . . , b*_{N}) be the values of all the wires in C on input [symbol] [k]\J.
      4. Let J′⊆[N] be the set of wires in the ith layer of C whose values b* are 0.
      5. Output f=(J′, s) where s=0^{J′} is the all-zero string.
A seBARG scheme (Definition 3.5)
   (Gen_{seBARG}, [symbol] _{seBARG}, [symbol] _{seBARG}, Extract_{seBARG}).

The analysis of the construction above follows identically to the analysis of the somewhere-extractable SNARG for monotone policy BatchNP in prior work. In particular, the G-functional subset extraction property follows similarly to the somewhere argument of knowledge property in prior work, and using the functional properties of the PEHash. We thus obtain Theorem 8.1.

9 BARGs with Adaptive Subset Extraction for Low-Depth Policies

In this section we give a batch argument with adaptive subset extraction for families of monotone policies implemented by a low-depth monotone circuits.

We proceed by defining low-depth monotone circuit families, then state our main theorem and a corollary.

Definition 9.1 (Depth-d Monotone Circuit Policies). Let d(λ) be a function and let F={F_{λ} [symbol] be a family of functions. F is a depth-d family of policies if there exist polynomials N(λ), k(λ) such that each f∈F_{λ} is a monotone function f: {0, 1}^{k}→{0, 1} computable by a monotone circuit C of size N and depth d.

Theorem 9.2. Assuming a somewhere extractable batch argument scheme and a hash family with local opening, there exists a scheme BARG=Setup, [symbol] , [symbol] , Extract) such that for any family F of depth-d policies where d=O(log λ), BARG is a F-batch argument with O(k·2^{d})-adaptive subset extraction for relation [symbol] _{full}.

Corollary 9.3. Assuming a somewhere extractable batch argument scheme and a hash family with local opening, there exists a scheme AggS=(Setup, KeyAgg, SigAgg, AggVerify) such that for any family F of depth-d policies where d=O(log Λ) and for any digital signature scheme S, AggS is a F-aggregation scheme for S.

10 Verifiable Private Information Retrieval (vPIR)

In this section we define vPIR. For simplicity and consistency with Section 6, we make the following modifications:
The Setup and Query algorithms are merged.
We do not consider verification with multiple queries.
We only consider publicly verifiable vPIR schemes.
We only consider read-once bounded-space constraints.
We consider simulation security for non-adaptive constraints. This differs from the definition in prior work, that considers adaptively chosen constraints, which requires limiting the constraint's description length to N=O(log λ). However, as noted in a remark in their work, simulation security for non-adaptive constraints holds even when their length is N≥Λ.

Read-once bounded-space constraints. For parameters T, S, we define a read-once bounded-space constraint represented as a Turing machine Γ∈{0, 1}^{N}. We say that a database D=(rᵢ)_{i∈[k]}∈{0, 1}^{k×ω}, satisfies Γ if and only if for every i∈[k−1] there exists cᵢ∈{0, 1}^{S} such that Γ(cᵢ₋₁, rᵢ) outputs cᵢ within T steps where c₀, cₖ are some fixed starting and accepting configurations. We denote by U_{T,S}(Γ, D) the bit that indicates whether or not D satisfies the constraint r.

Syntax. A verifiable private information retrieval(vPIR) scheme consists of following polynomial-time algorithms:
Query(1^{λ}, t)→(dk, vk, q). This is a probabilistic algorithm that takes as input the security parameter 1^{λ} and a row index t∈[2^{λ}]. It outputs a decryption key dk, a verification key vk and a query q.
Answer(D, 1^{T}, Γ, q)→a. This is a deterministic algorithm that takes as input a database D∈{0, 1}^{k×ω}, a time bound 1^{T}, a constraint Γ, and a query q. It outputs an answer a.
Dec(dk, a)→π. This is a deterministic algorithm that takes as input a decryption key dk, and an answer a. It outputs a row Γ∈{0, 1}^{ω}.
Verify(vk, Γ, a)→0/1. This is a deterministic algorithm that takes as input a verification key vk, a constraint Γ, and an answer a. It outputs a bit (1 to accept, 0 to reject).

Definition 10.1. A Λ-secure vPIR scheme (Query, Answer, Dec, Verify) for [symbol] is required to satisfy the following properties:
Completeness. For any λ∈ [symbol] , any T, N, S, k, ω≤2^{λ}, database D∈{0, 1}^{k×w}, row index t∈[k] and constraint Γ∈{0, 1}^{N} such that U_{T,S}(Γ, D)=1,

$$Pr [ \begin{matrix}Dec ( dk , a ) = D [ t ] ∧ \\ Verify ( vk , Γ , a ) = 1\end{matrix} : \begin{matrix}( dk , vk , q ) ← Query ( {1}^{λ} , t ) \\ a ← Answer ( D , {1}^{T} , Γ , q )\end{matrix} ] = 1 .$$

Efficiency. In the completeness experiment above, |vk|+|q|+|a|≤ω·poly(λ, log(kT)).
Λ-Privacy. For any poly(Λ)-size adversary [symbol] and function k(λ)≤Λ(λ) there exists a negligible function negl such that for any λ∈ [symbol] and row indices t₀, t₁∈[k(λ)],

$$Pr [ ( vk , q ) = b : \begin{matrix}b ← \{ 0 , 1 \} \\ ( dk , vk , q ) ← Query ( {1}^{λ} , {t}_{b} )\end{matrix} ] \leq \frac{1}{2} + negl ( Λ ) .$$

Λ-Simulation security. For any function T(λ), N(λ), k(λ), ω(λ)≤Λ(λ), function S(λ)=O(log Λ), any poly(Λ)-size adversary [symbol] and polynomial P there exists a poly(Λ)-size simulator Sim such that for any poly(Λ)-size distinguisher [symbol] , λ∈ [symbol] , constraint Γ and row index t∈[k],

$$\vert Pr [ ( {Real}_{} ( λ , Γ , t ) ) = 1 ] - Pr [ ( {Ideal}_{Sim} ( λ , Γ , t ) ) = 1 ] \vert < \frac{1}{P ( Λ )} ,$$

where the experiments Real [symbol] (λ, Γ, t) and Ideal_{Sim}(λ, Γ, t) are defined as follows:
Real [symbol] (λ, Γ, t):
   Generate a query (dk, vk, q)←Query (1^{λ}, t).
   Run the adversary and obtain a← [symbol] (vk, q).
   If Verify(vk, Γ, a)=1 output Dec(dk, a). Otherwise output ⊥.
Ideal_{Sim}(λ, Γ, t):
   Run the simulator and obtain D←Sim(λ, Γ).
   If U_{T,S}(Γ, D)=1 output D[t]. Otherwise output ⊥.

Theorem 10.2. Assuming a Λ-secure somewhere extractable batch argument scheme and a Λ-secure hash family with local opening, there exists a Λ-secure vPIR scheme for read-once bounded-space constraints.

### EXAMPLE EMBODIMENT APPLICATIONS

### Blockchain and Cryptocurrency Applications

In some cases, the signature system 100 may be utilized in various blockchain and cryptocurrency applications, leveraging the power of monotone-policy aggregate signatures to enhance security, efficiency, and flexibility in decentralized systems. The method 200 for generating an aggregate signature and the method 300 for verifying an aggregate signature may be particularly valuable in these contexts.

One significant application may be in the realm of multi-signature wallets. Traditional multi-signature implementations often require all signers to coordinate during wallet creation and typically support only simple threshold policies. However, the signature system 100 may allow for more complex authorization rules without necessitating interactive setup phases. For example, a multi-signature wallet may implement a policy such as “any 2 of 3 regular users AND at least 1 recovery key holder” using the aggregate signature generation method 200.

In this scenario, the common message 105 may represent a transaction to be authorized. Each local device (110, 120, 121, 123) may correspond to a different key holder. The key generation module 115 in each local device may generate a secret key 116 and verification key 117 pair. When a transaction needs to be authorized, the signature generation module 112 in each participating device may generate a message signature 113 using its secret key 116.

The signature aggregator module 130 may then combine these individual signatures into an aggregate signature 131, which can be verified by the verification module 135. The policy encoded in the aggregate signature may ensure that the required combination of regular users and recovery key holders have signed off on the transaction.

The verification process, as outlined in method 300, may involve receiving the signed common message at step 305, the aggregate signature at step 306, and the verification keys at step 307. The hash generator 136 may generate a hash digest of the received verification keys at step 308, which is then used in the verification process at step 309.

Another powerful application of the signature system 100 may be in the context of Decentralized Autonomous Organizations (DAOs). DAOs could implement sophisticated voting mechanisms where voting weight depends on token holdings, reputation scores, or stakeholder categories. For instance, a DAO might require “approval from 60 percent of token weight OR unanimous consent from the core developer multisig AND the treasury multisig.”

In this case, the common message 105 might represent a proposal to be voted on. Each local device (110, 120, 121, 123) may represent a different stakeholder or group of stakeholders. The signature generation module 112 in each device may generate a signature based on the stakeholder's voting power or role.

The signature aggregator module 130 may combine these signatures, taking into account the different weights or categories of the signers. The resulting aggregate signature 131 may encapsulate the complex voting logic, allowing for efficient verification by the verification module 135.

The sublinear verification time of the signature system 100, as described in claim 9, may be particularly beneficial in this scenario. If all parties sign the same message (in this case, the proposal), the verification time may be sublinear in t, where t represents the threshold number of signers. This property may allow the DAO to efficiently process votes even with a large number of participants.

Cross-chain verification is another area where the signature system 100 may provide significant benefits. As blockchain ecosystems become more interconnected, there's a growing need for secure and efficient cross-chain communication. The monotone-policy aggregate signatures generated by the signature system 100 may enable cross-chain verification with policies that account for the varying trust levels of different chains.

For example, a cross-chain transaction might require “signatures from 2 of 3 validators on the source chain AND 3 of 5 validators on the destination chain.” In this scenario, each local device (110, 120, 121, 123) may represent a validator from either the source or destination chain. The signature aggregator module 130 may combine the signatures from both chains, creating an aggregate signature 131 that encapsulates the cross-chain verification policy.

The verification module 135 may then efficiently verify this aggregate signature, ensuring that the required number of validators from each chain have approved the transaction. This approach may create more secure bridges between ecosystems, reducing the risk of cross-chain attacks.

In the context of proof-of-stake systems, the signature system 100 may enable more nuanced consensus rules than simple threshold approaches. Validator signatures could be weighted according to their stake amounts, leveraging the support for weighted thresholds described in claim 5 of the patent application.

For instance, in a proof-of-stake blockchain, each local device (110, 120, 121, 123) may represent a validator. The key generation module 115 in each device may generate a key pair where the verification key 117 is associated with the validator's stake amount. When participating in consensus, the signature generation module 112 may generate a signature, which is then sent to the signature aggregator module 130.

The signature aggregator module 130 may combine these signatures, taking into account the stake weight of each validator. The resulting aggregate signature 131 may represent a stake-weighted consensus decision. The verification module 135 may then efficiently verify this aggregate signature, ensuring that the required stake threshold has been met.

This approach may allow for more democratic and economically secure consensus mechanisms in proof-of-stake systems. Moreover, as stated in claim 11, the aggregation time may grow with the number of signatures t and not the number of parties k. This property may be particularly beneficial in large proof-of-stake networks, where the number of active validators (t) in a given consensus round may be much smaller than the total number of registered validators (k).

### Enterprise Systems Applications

The signature system 100 may also find significant applications in enterprise environments, where complex authorization policies and efficient verification are crucial. The ability to express intricate authorization rules without requiring interactive setup makes the system particularly valuable in corporate settings.

One key application may be in implementing hierarchical approval workflows. Corporate approval systems could leverage the signature system 100 to implement policies such as “any Vice President AND two Directors AND the department head” for financial authorizations. In this scenario, each level of the corporate hierarchy may be represented by a local device (110, 120, 121, 123) in the signature system 100.

For example, consider a financial transaction that requires approval from multiple levels of management. The common message 105 may represent the details of the financial transaction. Each approver's device may contain a key generation module 115 that generates a secret key 116 and verification key 117 pair specific to their role in the organization.

When the transaction needs approval, each relevant manager may use their local device to generate a signature using their signature generation module 112. These individual signatures may then be sent to the signature aggregator module 130, which combines them into an aggregate signature 131 that encodes the hierarchical approval policy.

The verification module 135 may then verify this aggregate signature, ensuring that the required combination of approvals has been obtained. This process may remain efficient even as the organization scales, because, as stated in claim 9, if all parties sign the same message, the verification time may be sublinear in t, where t represents the threshold number of signers.

Another valuable application in enterprise systems may be in regulatory compliance automation. For regulated industries, the signature system 100 could be used to ensure that transactions satisfy specific regulatory requirements. For instance, a policy might require signatures that satisfy the rule “the compliance officer AND the department head AND either the CFO or CEO.”

In this case, each of these roles may be associated with a local device (110, 120, 121, 123) in the signature system 100. The common message 105 may represent a transaction or decision that requires regulatory approval. Each required party may generate a signature using their signature generation module 112.

The signature aggregator module 130 may then combine these signatures into an aggregate signature 131 that encodes the regulatory compliance policy. The verification module 135 may verify this aggregate signature, ensuring that all regulatory requirements have been met. This approach may create an auditable enforcement of compliance requirements, as the aggregate signature 131 itself serves as cryptographic proof that the proper approvals were obtained.

The signature system 100 may also be particularly useful in multi-party contract execution scenarios. Legal agreements involving multiple organizations could establish signature policies that reflect the contractual requirements. For example, a merger agreement might require “signatures from the CEO, CFO, and legal counsel from each participating company.”

In this scenario, each party to the agreement may be represented by a local device (110, 120, 121, 123) in the signature system 100. The common message 105 may represent the contract document. Each required signatory may generate a signature using their signature generation module 112.

The signature aggregator module 130 may combine these signatures into an aggregate signature 131 that encodes the complex signing requirements of the multi-party agreement. The verification module 135 may then verify this aggregate signature, ensuring that all required parties have signed off on the agreement. This approach may allow each organization to maintain independent control of their keys while still enabling efficient verification of the collective agreement.

Distributed treasury management is another area where the signature system 100 may provide significant benefits. Corporate treasury operations could implement controls requiring different levels of authorization for different transaction amounts. For instance, a policy might state “any two financial officers AND the treasurer for transactions under $1M, or any three financial officers AND the CFO AND treasurer for transactions over $1M.”

In this case, each financial officer, the CFO, and the treasurer may have their own local device (110, 120, 121, 123) in the signature system 100. The common message 105 may represent a treasury transaction. Depending on the transaction amount, the appropriate signatories may generate signatures using their signature generation modules 112.

The signature aggregator module 130 may combine these signatures into an aggregate signature 131 that encodes the treasury control policy. The verification module 135 may then verify this aggregate signature, ensuring that the appropriate level of authorization has been obtained based on the transaction amount. This approach may allow for granular financial controls that align with enterprise governance requirements, while still maintaining efficient verification.

The signature system 100 may also be valuable in enforcing segregation of duties policies. Security policies requiring separation of responsibilities could be encoded as monotone policies, such as “approval from one person in group A AND one person in group B, where no individual belongs to both groups.”

Each group may be represented by a set of local devices (110, 120, 121, 123) in the signature system 100. The common message 105 may represent an operation that requires segregated approval. Signatories from each group may generate signatures using their signature generation modules 112.

The signature aggregator module 130 may combine these signatures into an aggregate signature 131 that encodes the segregation of duties policy. The verification module 135 may then verify this aggregate signature, ensuring that the required separation of responsibilities has been maintained. This approach may provide cryptographic enforcement of critical security policies that would otherwise rely on application-level controls.

In multi-organization supply chains, the signature system 100 may be used to create tamper-evident documentation that spans organizational boundaries. For example, a document authenticity policy might require “signatures from the manufacturer AND the quality inspector AND at least two logistics providers.”

Each party in the supply chain may be represented by a local device (110, 120, 121, 123) in the signature system 100. The common message 105 may represent a supply chain document or transaction. Each relevant party may generate a signature using their signature generation module 112.

The signature aggregator module 130 may combine these signatures into an aggregate signature 131 that encodes the supply chain verification policy. The verification module 135 may then verify this aggregate signature, ensuring that all required parties in the supply chain have signed off on the document or transaction. This approach may create a cryptographically verifiable trail of approvals across the supply chain, enhancing transparency and trust without requiring complex setup procedures between the various organizations involved.

The adaptability of the signature system 100 to complex organizational structures makes it particularly valuable for enterprises with sophisticated governance requirements or regulatory constraints. By offering cryptographic enforcement of authorization policies that would otherwise rely on application-level controls, the system may provide a higher level of security and auditability for critical business processes.

### Cross-Chain Bridges and Interoperability

The signature system 100 may play a crucial role in enhancing the security and efficiency of cross-chain bridges, which are critical infrastructure for enabling interoperability between distinct blockchain networks. Cross-chain bridges facilitate the transfer of assets, data, and smart contract states across chains that would otherwise operate in silos, and the signature system 100 may address several key challenges in this domain.

One of the primary challenges in cross-chain bridge design is the need for robust security mechanisms that can withstand potential attacks while maintaining efficiency. The signature system 100, with its support for expressive monotone policies and efficient verification, may provide a powerful tool for addressing these challenges.

For example, consider a cross-chain bridge that requires signatures from validators on both the source and destination chains to authorize a transfer. The policy might state “signatures from 7 out of 10 validators on the source chain AND 6 out of 8 validators on the destination chain.” In this scenario, each validator may be represented by a local device (110, 120, 121, 123) in the signature system 100.

The common message 105 may represent the cross-chain transfer transaction. Validators from both chains may generate signatures using their signature generation modules 112. The signature aggregator module 130 may then combine these signatures into an aggregate signature 131 that encodes the cross-chain validation policy.

The verification module 135 may efficiently verify this aggregate signature, ensuring that the required number of validators from each chain have approved the transaction. This approach may create a more secure bridge between ecosystems by cryptographically enforcing the participation of validators from both chains.

Moreover, the sublinear verification time of the signature system 100, as described in claim 9, may be particularly beneficial in this context. If all validators sign the same transfer message, the verification time may be sublinear in t, where t represents the threshold number of signers. This property may allow for efficient verification of cross-chain transfers even with a large number of validators involved.

The signature system 100 may also address the scalability challenges faced by cross-chain bridges. As blockchain ecosystems grow and the number of cross-chain interactions increases, the efficiency of verification becomes crucial. The system's ability to provide succinct proofs and efficient verification may help prevent bottlenecks in cross-chain operations.

For instance, in a scenario where a cross-chain bridge needs to handle transfers between multiple chains simultaneously, the signature system 100 may allow for the creation of complex, multi-chain validation policies. A policy might require “signatures from 2 out of 3 validators on chain λ AND 3 out of 5 validators on chain B AND 4 out of 6 validators on chain C.”

Each validator across the multiple chains may be represented by a local device (110, 120, 121, 123) in the signature system 100. The signature aggregator module 130 may combine signatures from validators across all involved chains into a single aggregate signature 131. This aggregate signature may encapsulate the entire multi-chain validation policy.

The verification module 135 may then efficiently verify this aggregate signature, ensuring that the required number of validators from each chain have approved the multi-chain operation. This approach may allow for complex, multi-chain interactions to be verified efficiently, potentially enabling new forms of cross-chain applications and protocols.

Furthermore, the adaptive security property of the signature system 100 may be particularly valuable in the context of cross-chain bridges. As stated in the patent application, the system provides resistance to adaptive subset extraction, ensuring that even if adversaries corrupt validators after seeing the common reference string (CRS), the threshold policy remains enforceable.

This property may be crucial for cross-chain bridges, where the set of validators may change over time and where adversaries might attempt to target specific validators after observing the system's parameters. The adaptive security of the signature system 100 may provide an additional layer of protection against such targeted attacks.

In the context of modular blockchains and rollup ecosystems, which increasingly depend on secure bridging for liquidity sharing and interoperability, the signature system 100 may offer significant advantages. For example, in a rollup system where multiple layer-2 solutions need to interact with a base layer, the signature system 100 could be used to create efficient and secure validation mechanisms for state transitions between layers.

A policy for such a system might require “signatures from 3 out of 5 rollup validators AND 2 out of 3 base layer validators.” Each validator, whether from the rollup or the base layer, may be represented by a local device (110, 120, 121, 123) in the signature system 100. The signature aggregator module 130 may combine signatures from both sets of validators into an aggregate signature 131 that encodes this multi-layer validation policy.

The verification module 135 may then efficiently verify this aggregate signature, ensuring that the required participation from both the rollup and base layer validators has been achieved. This approach may enable secure and efficient state transitions in complex, multi-layer blockchain architectures.

The signature system 100 may also address regulatory concerns surrounding cross-chain bridges. As bridges come under increased regulatory scrutiny due to their role in facilitating cross-chain transactions, the ability to create and efficiently verify complex authorization policies may become increasingly important.

For instance, a policy might require “signatures from 2 out of 3 bridge operators AND 1 compliance officer AND either the CFO or CEO of the bridge operating entity.” Each of these roles may be represented by a local device (110, 120, 121, 123) in the signature system 100. The signature aggregator module 130 may combine signatures from these various parties into an aggregate signature 131 that encodes this compliance-oriented policy.

The verification module 135 may efficiently verify this aggregate signature, ensuring that all regulatory requirements have been met. This approach may create an auditable trail of approvals for cross-chain transactions, potentially helping bridge operators meet evolving compliance demands.

### Detailed Description of Local, Remote, and Distributed Components

The present disclosure provides methods and systems for generating and verifying aggregate signatures of a message, which can be implemented in various types of computer systems and software tools. These systems can be local, cloud-based, or distributed, depending on the specific requirements of the system, performance requirements, and security considerations.

### Local Implementation

In a local implementation, all components of the aggregate signature generation and verification apparatus 100 are housed within a single device or system. This includes the local storage device, the local cryptographic module, the local signature generation module, the transmission module, the aggregator module, and the verification module. The local storage device stores the common message, and the local cryptographic module generates a secret cryptographic key and a verification cryptographic key pair for a user. The local signature generation module generates a user signature for the common message using the secret cryptographic key for the user. The transmission module transmits the user signature to the aggregator module, which combines the user signature with other user signatures to generate an aggregate signature. The aggregate signature is then transmitted to the verification module for verification.

### Remote Implementation

In a remote or cloud-based implementation, some or all components of the aggregate signature generation and verification apparatus 100 may be housed on a remote server or cloud platform. The common message and the user signatures may be transmitted to the remote server or cloud platform over a network, and the aggregate signature generation and verification processes are performed remotely. The aggregate signature is then transmitted back to the local device or system for further use or storage. This approach can offload the computational work to the cloud, reducing the resource requirements on the local device but may introduce potential security risks due to the reliance on a third-party service.

### Distributed Implementation

In a distributed implementation, the components of the aggregate signature generation and verification apparatus 100 are distributed across multiple devices or nodes in a network. Each node may store a portion of the common message and generate a portion of the user signatures. The user signatures are then transmitted to an aggregator node, which combines the user signatures to generate an aggregate signature. The aggregate signature is then transmitted to a verification node for verification. This approach can provide better fault tolerance and scalability but may require more complex coordination and communication among the participating nodes.

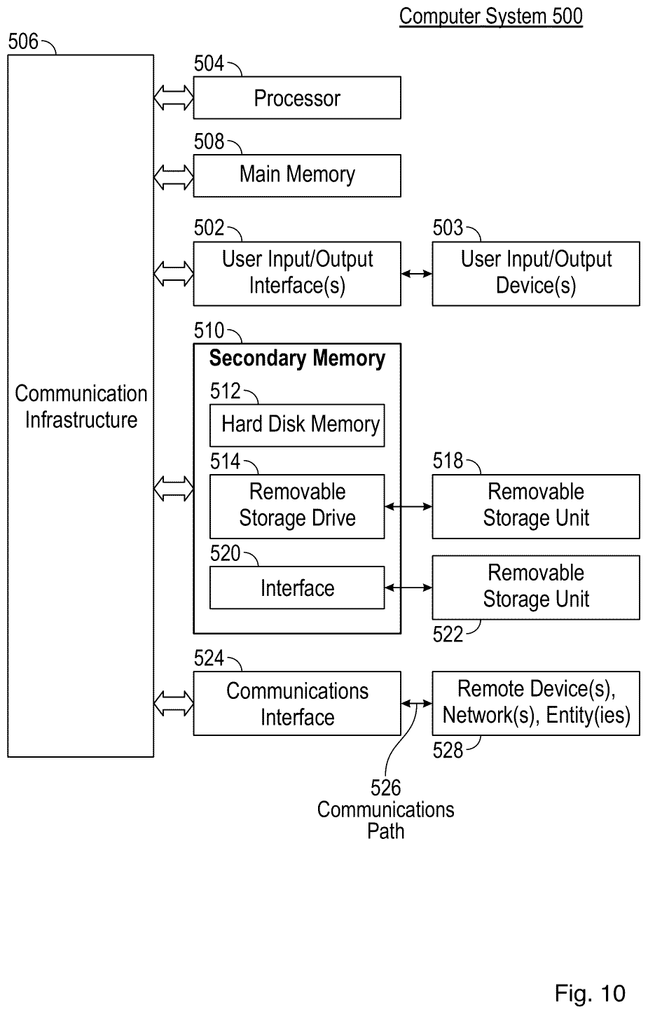

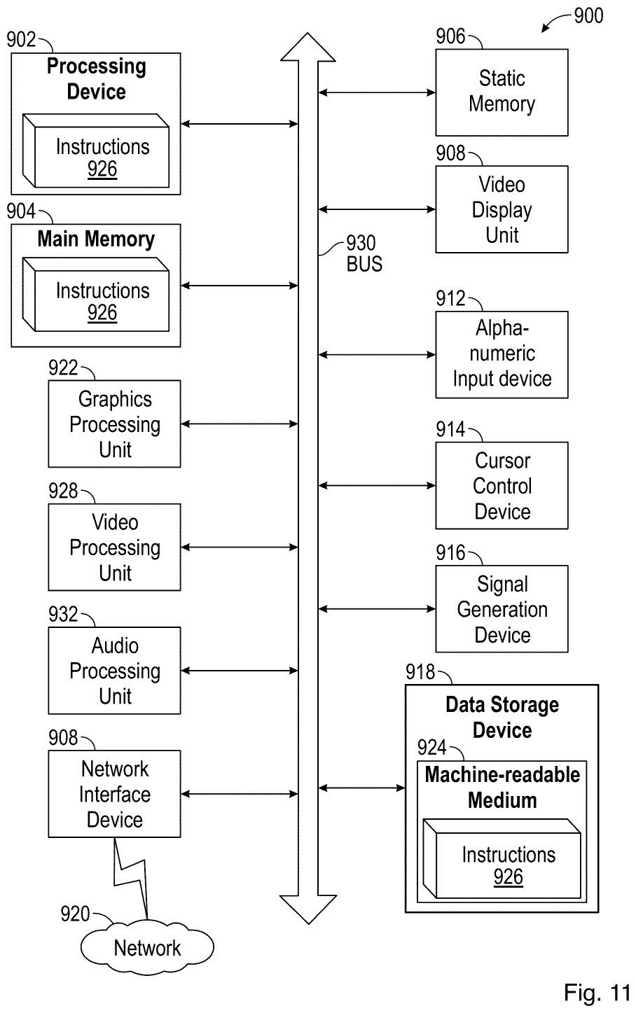

FIGS. 10 and 11 depict example computer systems useful for implementing various embodiments described in the present disclosure. Various embodiments may be implemented, for example, using one or more computer systems, such as computer system 500 shown in FIG. 10. One or more computer system(s) 500 may be used, for example, to implement any of the embodiments discussed herein, as well as combinations and sub-combinations thereof.

Computer system 500 may include one or more processors (also called central processing units, processing devices, or CPUs), such as a processor 504. Processor 504 may be connected to a communication infrastructure 506 (e.g., such as a bus).

Computer system 500 may also include user input/output device(s) 503, such as monitors, keyboards, pointing devices, etc., which may communicate with communication infrastructure 506 through user input/output interface(s) 502. One or more of processors 504 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 may also include a main memory 508, such as random-access memory (RAM). Main memory 508 may include one or more levels of cache. Main memory 508 may have stored therein control logic (i.e., computer software, instructions, etc.) and/or data. Computer system 500 may also include one or more secondary storage devices or secondary memory 510. Secondary memory 510 may include, for example, a hard disk drive 512 and/or a removable storage device or removable storage drive 514. Removable storage drive 514 may interact with a removable storage unit 518. Removable storage unit 518 may include a computer-usable or readable storage device having stored thereon computer software (control logic) and/or data. Removable storage drive 514 may read from and/or write to removable storage unit 518.

Secondary memory 510 may include other means, devices, components, instrumentalities, or other approaches for allowing computer programs and/or other instructions and/or data to be accessed by computer system 500. Such means, devices, components, instrumentalities, or other approaches may include, for example, a removable storage unit 522 and an interface 520. Examples of the removable storage unit 522 and the interface 520 may include a program cartridge and cartridge interface, a removable memory chip (such as an EPROM or PROM) and associated socket, a memory stick and USB port, a memory card and associated memory card slot, and/or any other removable storage unit and associated interface.

Computer system 500 may further include communications interface 524 (e.g., network interface). Communications interface 524 may enable computer system 500 to communicate and interact with any combination of external devices, external networks, external entities, etc. (individually and collectively referenced as remote device(s), network(s), entity(ies) 528). For example, communications interface 524 may allow computer system 500 to communicate with external or remote device(s), network(s), entity(ies) 528 over communications path 526, which may be wired and/or wireless (or a combination thereof), and which may include any combination of LANs, WANs, the Internet, etc. Control logic and/or data may be transmitted to and from computer system 500 via communications path 526.

Computer system 500 may also be any of a personal digital assistant (PDA), desktop workstation, laptop or notebook computer, netbook, tablet, smartphone, smartwatch or other wearable devices, appliance, part of the Internet-of-Things, and/or embedded system, to name a few non-limiting examples, or any combination thereof.

Computer system 500 may be a client or server computing device, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

FIG. 11 illustrates an example machine of a computer system 900 within which a set of instructions, for causing the machine to perform any one or more of the operations discussed herein, may be executed. In alternative implementations, the machine may be connected (e.g., networked) to other machines in a LAN, an intranet, an extranet, and/or the Internet. The machine may operate in the capacity of a server or a client machine in a client-server network environment, as a peer machine in a peer-to-peer (or distributed) network environment, or as a server or a client machine in a cloud computing infrastructure or environment.

The machine may be a personal computer (PC), a tablet PC, a set-top box (SM), a Personal Digital Assistant (PDA), a cellular telephone, a web appliance, a server, a network router, a switch or bridge, a specialized application or network security appliance or device, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 900 includes a processing device 902, a main memory 904 (e.g., read-only memory (ROM), flash memory, dynamic random-access memory (DRAM) such as synchronous DRAM (SDRAM), etc.), a static memory 906 (e.g., flash memory, static random-access memory (SRAM), etc.), and a data storage device 918, which communicate with each other via a bus 930.

Processing device 902 represents one or more processing devices such as a microprocessor, a central processing unit, or the like. More particularly, the processing device may be complex instruction set computing (CISC) microprocessor, reduced instruction set computing (RISC) microprocessor, very long instruction word (VLIW) microprocessor, or processor implementing other instruction sets, or processors implementing a combination of instruction sets. Processing device 902 may also be one or more special-purpose processing devices such as an application-specific integrated circuit (ASIC), a field-programmable gate array (FPGA), a digital signal processor (DSP), network processor, or the like. The processing device 902 is configured to execute instructions 926 for performing the operations and steps discussed herein.

The computer system 900 may further include a network interface device 908 to communicate over the network 920. The computer system 900 also may include a video display unit 910, an alphanumeric input device 912 (e.g., a keyboard), a cursor control device 914 (e.g., a mouse), a graphics processing unit 922, a signal generation device 916 (e.g., a speaker), graphics processing unit 922, video processing unit 928, and audio processing unit 932.

The data storage device 918 may include a machine-readable medium 924 (also known as a computer-readable storage medium) on which is stored one or more sets of instructions 926 (e.g., software instructions) embodying any one or more of the operations described herein. The instructions 926 may also reside, completely or at least partially, within the main memory 904 and/or within the processing device 902 during execution thereof by the computer system 900, where the main memory 904 and the processing device 902 also constitute machine-readable storage media.

In an example, the instructions 926 include instructions to implement operations and functionality corresponding to the disclosed subject matter. While the machine-readable storage medium 924 is shown in an example implementation to be a single medium, the term “machine-readable storage medium” should be taken to include a single medium or multiple media (e.g., a centralized or distributed database, and/or associated caches and servers) that store the one or more sets of instructions 926. The term “machine-readable storage medium” shall also be taken to include any medium that is capable of storing or encoding a set of instructions 926 for execution by the machine and that cause the machine to perform any one or more of the operations of the present disclosure. The term “machine-readable storage medium” shall accordingly be taken to include, but not be limited to, solid-state memories, optical media, and magnetic media.

Some portions of the detailed description have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a computer selectively activated or reconfigured by a computer program stored in the computer. Such a computer program may be stored in a computer-readable storage medium, such as but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The operations and illustrations presented herein are not inherently related to any particular computer or other apparatus. Various types of systems may be used with programs in accordance with the teachings herein, or it may prove convenient to construct a more specialized apparatus to perform the operations. The structure for a variety of these systems will appear as set forth in the description herein. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as read-only memory (“ROM”), random access memory (“RAM”), magnetic disk storage media, optical storage media, flash memory devices, etc.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), may cause such data processing devices to operate as described herein.

Based on the teachings contained in this disclosure, it will be apparent to persons skilled in the relevant art(s) how to make and use embodiments of this disclosure using data processing devices, computer systems, and/or computer architectures other than that shown in FIGS. 10 and 11. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible and are within the scope and spirit of this disclosure. For example, and without limiting the generality of this paragraph, embodiments are not limited to the software, hardware, firmware, and/or entities illustrated in the figures described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments but should be defined only in accordance with the following claims and their equivalents. In the foregoing specification, implementations of the disclosure have been described with reference to specific example implementations thereof. It will be evident that various modifications may be made thereto without departing from the broader spirit and scope of implementations of the disclosure as set forth in the following claims. The specification and drawings are, accordingly, to be regarded in an illustrative sense rather than a restrictive sense.

1. A method for generating an aggregate signature σf a message, the method comprising:
at a local storage device, storing a common message;
at a local key generation module, generating a secret cryptographic signing key and a public cryptographic verification key pair for a user using a collision-resistant hash function, and transmitting the public cryptographic verification key to a hash generation module;
at a local signature generation module, generating a user signature for the common message using the secret cryptographic signing key for the user;
transmitting the user signature to an aggregator module;
at the aggregator module, combining the user signature for the common message with other user signatures for the common message received from other users to generate an aggregate signature using non-interactive batch arguments;
transmitting the aggregate signature to a verification module; wherein
the aggregate signature is constructed from the non-interactive batch arguments that support adaptive subset extraction for expressive monotone policies, wherein:
a size of the aggregate signature is sublinear in a number of signers and is based on a security parameter λ;
the non-interactive batch arguments are constructed from verifiable private information retrieval; and
the aggregate signature is capable of being verified in sublinear time O(log k) when all parties sign the common message, where k is the number of signers.

2. The method of claim 1, wherein the non-interactive batch arguments that support adaptive subset extraction for monotone policies are constructed from Verifiable Private Information Retrieval.

3. The method of claim 1, wherein an untrusted aggregator party combines the signatures of multiple parties into an aggregate signature \hat{σ} to certify expressive monotone policies over the signatures.

4. The method of claim 3, wherein at least t out of k parties signed the common message.

5. The method of claim 3, further comprising weighted thresholds where each party has a different weight and a signing policy is defined with respect to a sum of the party weights.

6. The method of claim 1, wherein: the method relies only on standard cryptographic assumptions; and constructions are in a common reference string (CRS) model where a size of the CRS grows only polylogarithmically in the number of signers.

7. The method of claim 1, wherein:
the size of the aggregate signature is sublinear in k and t and only depends on the security parameter λ; and
if all parties sign the common message, the verification time is sublinear in t.

8. The method of claim 1, wherein:
if a vector of messages has a succinct representation, the verification time is sublinear in t; and
aggregation time grows with a number of signatures t and not the number of signers k.

9. A method for verifying an aggregate signature σf a message, the method comprising:
at a local storage device, storing a common message;
at a local key generation module, generating a secret key and a verification key pair for a user, and transmitting the verification key to a hash generation module;
at a local signature generation module, generating a user signature for the common message using the secret key for the user;
transmitting the user signature to an aggregator module;
at the aggregator module, combining the user signature for the common message with other user signatures for the common message received from other users to generate an aggregate signature;
transmitting the aggregate signature to a verification module;
at the verification module, receiving the common message that has been signed by multiple users;
receiving the aggregate signature for the signed common message;
receiving verification keys from one or more of the multiple users that signed the common message;
generating a hash digest of the received verification keys;
verifying the aggregate signature for the signed common message based on the hash digest of the received verification keys, the common message, and the aggregate signature for the signed common message; and
storing a result of the verification of the aggregate signature;
wherein the aggregate signature is constructed from non-interactive batch arguments that support adaptive subset extraction for expressive monotone policies.

10. The method of claim 9, wherein the verifying is performed without knowing an identity of the multiple users that signed the common message.

11. An apparatus for generating an aggregate signature σf a message, the apparatus comprising:
a local storage device configured to store a common message;
a local key generation module configured to generate a secret key and a verification key pair for a user, and transmit the verification key to a hash generation module;
a local signature generation module configured to generate a user signature for the common message using the secret key for the user;
a transmission module configured to transmit the user signature to an aggregator module;
the aggregator module configured to combine the user signature for the common message with other user signatures for the common message received from other users to generate an aggregate signature;
the transmission module further configured to transmit the aggregate signature to a verification module; and
wherein:
the aggregate signature is constructed from non-interactive batch arguments that support adaptive subset extraction for expressive monotone policies;
a size of the aggregate signature is sublinear in a number of signers and is based on a security parameter λ;
the non-interactive batch arguments are constructed from verifiable private information retrieval; and
the aggregate signature is capable of being verified in sublinear time O(log k) when all parties sign the common message, where k is the number of signers.

12. The apparatus of claim 11, wherein the non-interactive batch arguments that support adaptive subset extraction for monotone policies are constructed from Verifiable Private Information Retrieval.

13. The apparatus of claim 11, wherein an untrusted aggregator party combines the signatures of multiple parties into an aggregate signature to certify expressive monotone policies over the signatures.

14. The apparatus of claim 13, wherein:
at least a threshold number of parties signed the common message; and
further comprising a weighted threshold module where each party has a different weight and a signing policy is defined with respect to a sum of the party weights; and
wherein the apparatus relies on standard cryptographic assumptions.

15. The apparatus of claim 11, wherein the non-interactive batch arguments are in a common reference string (CRS) model where a size of the CRS grows polylogarithmically with the number of signers.

16. The apparatus of claim 11, wherein the size of the aggregate signature is sublinear in the number of signers and a threshold number of signers and depends on the security parameter λ.

17. The apparatus of claim 11, wherein:
if all parties sign the common message, a verification time is sublinear in a threshold number of signers; and
if a vector of messages has a succinct representation, the verification time is sublinear in the threshold number of signers.

18. The apparatus of claim 11, wherein an aggregation time grows with a number of signatures and not the number of signers.

19. An apparatus for verifying an aggregate signature σf a message, the apparatus comprising:
a local storage device configured to receive a common message that has been signed by multiple users;
a first reception module configured to receive an aggregate signature for the signed common message;
a second reception module configured to receive verification cryptographic keys from one or more of the multiple users that signed the common message;
a hash generation module configured to generate a hash digest of the received verification cryptographic keys;
a verification module configured to verify the aggregate signature for the signed common message based on the hash digest of the received verification cryptographic keys, the common message, and the aggregate signature for the signed common message;
a storage module configured to store a result of the aggregate signature verification; and
wherein the aggregate signature is constructed from non-interactive batch arguments that support adaptive subset extraction for expressive monotone policies.

20. The apparatus of claim 19, wherein the verification module is configured to verify the aggregate signature without knowing an identity of the multiple users that signed the common message.
